(19) United States
(12) Patent Application Publication
(10) Pub. No.: US 2008/0293581 A1
(43) Pub. Date: Nov. 27, 2008

(54) Rna Expression Microarrays

(76) Inventors: Charles E. Rogler, Carmel, NY (US); Tatyana Tchaikovskaya, Bronx, NY (US); Christopher Plescia, New York, NY (US)

Correspondence Address: AMSTER, ROTHSTEIN & EBENSTEIN LLP, 90 PARK AVENUE, NEW YORK, NY, 10016, US

(21) Appl. No.: 11/579,667

(22) PCT Filed: May 23, 2005
(86) PCT No.: PCT/US05/17899

§ 371 Date: Jun. 13, 2008

Related U.S. Application Data
(60) Provisional application No. 60/573,898, filed on May 24, 2004.

(51) Int. Cl. C40B 30/04; C40B 40/08

(52) U.S. Cl. 506/9; 506/17

(57) ABSTRACT

Provided are microarrays comprising spots comprising mixtures of cDNA molecules, the cDNA mixture being complementary and substantially quantitatively proportional to a mixture of mRNA molecules present in a cell or group of cells. Also provided are methods for determining expression of a gene in a cell or group of cells using the invention microarrays. Additionally provided are methods of determining the difference in expression of a first gene between a first cell or group of cells and a second cell or group of cells, using the invention microarrays. Also provided are microarrays comprising short RNAs, and methods of using these microarrays for detecting and quantifying microarrays in cells.

### CROSS-REFERENCE TO RELATED APPLICATION

This application claims the benefit of U.S. Provisional Application No. 60/573,898, Filed May 24, 2004.

### BACKGROUND OF THE INVENTION

(1) Field of the Invention

The present invention generally relates to microarrays and methods of evaluating gene expression using microarrays. More specifically, the invention relates to microarrays of cDNA copies of cellular extracts or short RNAs, and the use of those microarrays for evaluating expression of genes or short RNAs.

(2) Description of the Related Art

### REFERENCES CITED

Alizaeh A. A., Eisen M. B., Davis R. E. et al. Distinct types of diffuse large B-cell lymphoma identified by gene expression profiling. Nature 403: 503-511 (2000).
Andre, C., Jacquot, Y., Truong, T. T., Thomassin, M., Robert. J. F., and Y. C. Guillaume, Analysis of the progesterone displacement of its human serum albumin binding site by beta-estradiol using biochromatographic approaches: effect of two salt modifiers. J. of Chromatography B. 769: 267-281, (2003)
Anonymous. Human RNA Chip™, CLONTECHniques, October, 2000.
Augenlicht L. H., Wadler S., Corner G., Richards C., Ryan L., Multani A. S., Pathak S., Benson A., Haller D., and Heerdt B. G. Low-level c-myc amplification in human colonic carcinoma cell lines and tumors: a frequent, p53-independent mutation associated with improved outcome in a randomized multi-institutional trial. Cancer Research 57: 1769-1775 (1997).
Becker B., Thomas Vogt, Michael Landthaler, and Willhelm Stolz. Detection of differentially regulated genes in keratinocytes by cDNA array hybridization: Hsp27 and other novel players in response to artificial ultraviolet radiation. J Invest Dermatol. 116:983-988 (2001).
Bittner M., Meltzer P., Chen Y., Jiang Y., Seftor E., Hendrix M., Radmacher M., Simon R., Yakhini Z., Ben-Dor A., Sampas N., Dougherty E., Wang E., Marincola F., Gooden C., Lueders J., Glatfelter A., Pollack P., Carpten J., Gillanders E., Leja D., Dietrich K., Beaudry C., Berens M., Alberts D., Sondak V., Hayward N., and Trent, J. Molecular classification of cutaneous malignant melanoma by gene expression profiling. Nature 406:536-540 (2000).
Brown, P. O. and D. Botstein, Exploring the new world of the genome with DNA microarrays. Nature Genet Supp 21:33-37 (1999).
Chenchik, A., Zhu Y. Y., Diatechenko L, Li R., Hill J., and P. D. Siebert. Generation of high quality cDNA from small amounts of total RNA by SMART PCR, p. 305-319 ln P. D. Siebert and J. W. Larrick (Eds), Gene Cloning and Analysis of RT-PCR. Eaton Publishing, Natick, Mass. (1998).
Cheung V. G., Morley M., Aguilar F., Massimi A., Kucherlapati R., Childs G. Making and reading microarrays. Nature Genetics 21(1 Suppl): 15-9 (1999).
Dugast-Darzacq, C., et al Oncogene 23:8887-8899 (2004).
Eberwine, J. Amplification of mRNA populations using aRNA generated from immobilized oligo(dT)-T7 primed cDNA. Biotechniques 20:584-591 (1996).
Emmert-Buck M. R. et al. Laser capture microdissection. Science 27: 467-1001 (1996).
Fink L., Kohlhoff S., Stein M. M., Hanze J., Weissmann N., Rose F., Akkayagil E., Manz D., Grimminger F., Seeger W., and Bohle R. M. CDNA Array hybridization after laser-assisted microdissection from nornneoplastic tissue. Am. J. Path 160:81-90 (2002).
Hahn W. C. and Weinberg R A. Nature Reviews. Cancer 2(5):33141 (2002).
Hanahan D. and Weinberg R. A. Hallmarks of Cancer. Cell 100:57-70 (2000).
Iyer, V. R., Eisen, M. B., Ross, D. T., Schuler, G., Moore, T., Lee, J. C. F., Trent, J. M., Staudt, L. M., Hudson, J. Jr., Boguski, M. S., Lashkari, D., Shalon, D., Botstein, D., and Brown, P. O. The transcriptional program in the response of human fibroblasts to serum. Science 283:83-87 (1999).
Holstege F. C. P., Jennings E. G., Wyrick J. J., Lee T. I., Hengartner C. J., Green, M. R., Golub T. R., Lander E. S., and Young R. A. Dissecting the regulatory circuitry of a eukaryotic genome. Cell 95:717-728 (1998).
Kafatos, F. C., Jones, C. W., and A. Efstratiadis, Determination of nucleic acid sequence homologies and relative concentrations by a dot hybridization procedure Nucl. Acids Res. 7:1541-1552 (1979)
Kaminski N., Allard J. D., Pittet J. F., Zuo F., Griffiths M. J. D., Morris D., Huang Z., Sheppard D., and Heller R. A. Global analysis of gene expression in pulmonary fibrosis reveals distinct programs regulating lung inflammation and fibrosis. Proc. Natl. Acad. Sci. 97:1778-1783 (2000).
Kestler D P, Hill M., Agarwal S., and Hall RE. Use of bidirectional blots in differential display analysis. Analytical Biochemistry 280:216-220 (2000).
Kinzler, K. W. and Vogelstein, B. Cell 87:159-170 (1996).
Kitahara O., Furukawa Y., Tanaka T., Kihara C., Ono K., Yanagawa R., Nita M. E., Takagi T., Nakamura Y., and Tsunoda T. Alterations of gene expression during colorectal carcinogenesis revealed by cDNA microarrays after laser-capture microdissection of tumor tissues and normal epithelia. Cancer Research 61: 3544-3549 (2001).
Kononen J., Bubendorf L., Kallioniemi A., Barlund M., Schraml P., Leighton S., Torhorst J., Mihatsch M. G., Sauter G., and Kallioniemi O. P. Tissue microarrays for high-throughput molecular profiling of tumor specimens Nature Medicine 4: 844-847 (1998).
Kurreck J. et al. Design of antisense oligonucleotides stabilized by locked nucleic acids. Nucleic Acids Res. 20:1911-1918.
Lewin B. Eukaryotic Gene Expression, Chapter 28 and 29, in Genes VI, B. Lewin editor, Oxford University Press, Oxford, N.Y. and Tokyo (1997).
Livak K. and Schmittgen T. D. Analysis of relative gene expression data using real-time quantitative PCR and the 2^{-ΔΔC}_{T} method. Methods 25:402-408 (2001).
Luo L. et al. Gene expression profiles of laser-captured adjacent neuronal subtypes. Nature Medicine 5: 117-121 (1999).
Luzzi V., Mahadevappa M., Raja R., Warrington J. A., Watson M. A. Accurate and reproducible gene expression profiles from laser capture microdissection, transcript amplification, and high density oligonucleotide microarray analysis. Journal of Molecular Diagnostics. 5(1): 9-14 (2003).
Martinez-Chantar M. L., Corrales F. J., Martinez-Cruz L. A., Garcia-Trevijano E. R, Huang Z. Z., Chen L., Kanel G., Avila M. A., Mato J. M., and Lu S. C. Spontaneous oxidative stress and liver tumors in mice lacking methionine adenosyltransferase 1A. FASEB Journal. 16(10): 1292-4 (2002).
Mathiassen S., Lauemoller S. L., Ruhwald M., Claesson M. H., Buus S. Tumor-associated antigens identified by mRNA expression profiling induce protective anti-tumor immunity. European Journal of Immunology. 31(4): 123946 (2001).
Modrek, B. and C. Lee. Nature Genetics 30:13-19 (2002).
Plescia, C. P., Rogler, C. E., and L. E. Rogler, Genomic expression analysis implicates Wnt signaling pathway and extracellular matrix alterations in hepatic specification and differentiation of murine hepatic stem cells. Differentiation 68: 254-269 (2001).
Resch, A., et. al. J. Proteome Res 3: 76-83 (2003).
Robert R., Klevecz J. B., Forrest G., and Murray D. B. A Genome wide oscillation in transcription gates DNA replication and cell cycle. Proc. Natl. Acad. Sci. 101: 1200-1205 (2004).
Sambrook J., and Russell D. W. Molecular cloning: a laboratory manual. Cold Spring Harbor, N.Y.: Cold Spring Harbor Laboratory Press, p A6.5, A6.11-13 (2001).
Shalon, T. D., DNA Micro arrays: a new tool for genetic analysis. Ph. D Thesis, Stanford University, UMI Dissertation services, Ann Arbor Mich., p 29-33 (1995).
Schena, M., Shalon, D., Davis, R. W., and Brown, P. O. Quantitative monitoring of gene expression patterns with a complementary DNA microarray. Science 270:467-470 (1995).
Schena, M., Shalon D., Heller R., Chai A., Brown P. O., and R. W. Davis. Parallel human genome analysis: Microarray-based expression monitoring of 1000 genes. Proc. Natl. Acad. Sci. 93:10614-10619 (1996).
Schreiber-Agus, N., et. al. Oncogene 9:3167-3177 (1994).
Velculescu V E., Zhang L., Vogelstein B., Kinzler K W. Serial analysis of gene expression. Science. 270:484-7 (1995).
Vengellur A. Woods B. G., Ryan H. E., Johnson R. S., LaPres J. J. (2003) Gene expression profiling of the hypoxia signaling pathway in hypoxia-inducible factor 1alpha null mouse embryonic fibroblasts. Gene Expression 11(34): 181-97 (2003).
Vernon S D., Unger E R., Rajeevan M., Dimulescu I M., Nisenbaum R., and C E. Campbell. Reproducibility of alternative probe synthesis approaches for gene expression profiling with arrays. J Mol. Diag. 2:124-127 (2000).
Wang, E, Lance D. Miller, Galen A. Ohnmacht, Edison T. Liu, and Francesco M. Marinocola. High-fidelity mRNA amplification for gene profiling. Nature Biotechnology, 18:457-459 (2000).
Watson J. D. et al. (1987) The steps in protein synthesis, Chapters 13-15, in Molecular Biology of the Gene, editors Watson, Hopkins, Roberts, Steitz, and Weiner. Benjamin/Cummings Publishing Co. Menlo Park Calif.
Winer J., Kwang C., Jung S., Shackel I., and Williams P. M. Development and Validation of Real-Time Quantitative Reverse Transcriptase-Polymerase Chain Reaction for Monitoring Gene Expression in Cardiac Anal. Biochem. 270; 41-49 (1999).
Yu Y., Khan J., C Khanna, Helman L., Meltzer P. S., and Merlino G. Expression profiling identifies the cytoskeletal organizer ezrin and the developmental homeoprotein Six-1, as key metastatic regulators Nature Medicine 10: 175-181 (2004).
Zhu, Y. Y., E. M. Machleder, A. Chenchik, R Li, and P. D. Siebert. Reverse transcriptase template switching: a SMART™ approach for full-length cDNA library construction. BioTechniques, 30:892-897 (2001).
Zhumabayeva, B., Diatchenko, L., Chenchik. A., and P. D. Siebert. Use of SMART generated cDNA for gene expression studies in multiple human tumors. BioTechniques 30: 1-7 (2001).
U.S. Pat. No. 5,994,076.
U.S. Pat. No. 6,040,138.
U.S. Pat. No. 6,077,673.
U.S. Pat. No. 6,087,102.

One of the first steps in the discovery of the function of a gene is to determine its temporal and spatial pattern of expression. The transcriptional profile of gene expression is a valuable tool in determining gene function because the experience of the past thirty years of molecular biology has demonstrated that there is a tight correlation between the expression of a gene product and its function (Lewin, 1997; Brown and Botstein, 1999). In fact, a general rule has emerged as a result of numerous investigations of gene expression patterns. That is, “each gene is expressed in the specific cells under the specific conditions in which its product makes a contribution to fitness” (Brown and Botstein, 1999, Watson et al., 1987). We term this the “expression niche” of a gene.

The invention of cDNA microarrays has provided researchers with a tool that allows them to investigate patterns of gene expression on a genome wide scale (Schena et al., 1995; 1996; Iyer et al., 1999). Using cDNA microarrays researchers can simultaneously measure steady state mRNA levels in all the known genes and thousands of Expressed Sequence Tags (ESTs) expressed in a cell (Plecia et al., 2001; Robert et al., 2004; Kutahara et al., 2001; Holstege et al., 1998). Using cDNA microarrays, researchers obtain a large body of data on the differential expression of thousands of genes in a limited set (generally 1-10) of experimental samples (Schena et al., 1995; 1996; Iyer et al., 1999; Plescia et al., 2001; Robert et al., 2004; Kitahara et al., 2001; Holstege et al., 1998). Very significant discoveries on classifying tumors and identification of novel genes potentially involved in defined sets of tumors have been made using cDNA microarrays (Bittner et al., 2000; Kaminski et al., 2000; Allzaeh et al., 2000).

Microarrays can be divided into two types. The most common type of microarray consists of probes that are affixed or attached to a solid substrate in an array pattern, with each probe representing a defined nucleotide sequence. Targets consisting of labeled nucleic acid samples are contacted with the array in a manner permitting hybridization. This type of microarray is particularly useful for determining the expression pattern of thousands of genes in one tissue sample. Examples of this type of microarray are described in U.S. Pat. Nos. 5,994,076; 6,040,138; and 6,077,673.

In the second type of microarray, targets consisting of nucleic acid samples are attached to a solid substrate in an array pattern. Labeled probes representing defined nucleotide sequences are applied to the targets to permit hybridization. This type of microarray is particularly useful for detecting the expression pattern for a specific gene of interest in a wide variety of cells or tissues. Examples of the second type of microarray include Clontech's Human RNA Chip® (BD Biosciences, Palo Alto, Calif.; see Anonymous, 2000), described in U.S. Pat. No. 6,087,102.

Follow up experiments to define the functions of candidate genes take many forms. One approach is to determine whether the gene is over-expressed in other tumors and cell lines and how the gene is expressed in normal tissues and tissues from gene knockout mice (Vengellur et al., 2003; Martinez-Chantar et al., 2002; Mathiassen et al., 2001). These experiments are very labor intensive, expensive and often beyond the capabilities of most laboratories. Therefore, use of cDNA microarray data has heightened the need to develop high throughput companion assays to measure the transcription of genes in a broad spectrum of healthy and diseased states, for example cancer.

Malignant transformation occurs after a cell has altered the “expression niche” of genes that affect its phenotype. Common features of malignant tumor cells include: 1) Self sufficiency of growth signals (proto-oncogene activation); 2) Insensitivity to anti-growth signals (loss of tumor suppressor function); 3) Avoidance of apoptosis; 4) Acquiring of limitless growth potential; 5) Ability to sustain angiogenesis, and 6) Development of invasive properties and metastasis (Hanahan and Weinberg, 2000).

The role of transcriptional changes in cells acquiring the above phenotypes is a particularly active area of research in cancer biology (Bittner et al., 2000; Yu et al., 2004). As new oncogenes or tumor suppressor genes are linked to one tumor type, information on their expression in a wide range of tumors and normal tissues is sought. These survey experiments help investigators to devise hypotheses on the function of the gene in tumor and normal tissues. Therapeutic approaches can also emerge based on transcriptional data.

Thus, a key approach to discovering gene function is to determine the broad contexts in which a gene is expressed (Brown and Botstein, 1999; Lewin, 1997; Watson et al., 1987). While cDNA microarrays provide a valuable tool to determine the expression pattern of thousands of genes simultaneously in defined sets of samples (Schena et al., 1995; 1996; Iyer et al., 1999; Plescia et al., 2001; Bittner et al., 2000; Yu et al., 2004; Robert et al., 2004; Kitahara et al., 2001; Allzaeh et al., 2000; Mathiassen et al., 2001; Kaminski et al., 2000), there is a need for a high throughput experimental approach to define the expression profile of selected candidate genes in a broad range of pathophysiological samples, normal tissues, cell cultures, and developmental biology contexts.

### SUMMARY OF THE INVENTION

Accordingly, the inventors have discovered that certain formats of microarrays and microarray assays provide unexpectedly accurate and reproducible measurements of expression of genes in a cell or group of cells, where the microarrays comprise spots of mixtures of cDNAs of mRNAs present in a cell or group of cells.

Thus, in some embodiments, the invention is directed to microarrays comprising a nonporous support, the microarray further comprising a plurality of spots, each spot affixed at identifiable locations on the surface of the support, wherein each spot comprises a mixture of cDNA molecules, the cDNA mixture being complementary and substantially quantitatively proportional to a mixture of mRNA molecules present in a cell or group of cells.

In other embodiments, the invention is directed to methods of making a microarray comprising a nonporous support. The methods comprise applying a plurality of spots to the support, where each spot is applied to an identifiable location on the surface of the support. In these methods, each spot comprises a mixture of cDNA molecules, the mixture of cDNA molecules being proportional to a mixture of mRNA complementary to the cDNA, and the mixture of mRNA substantially quantitatively representing the mRNA population from a cell or group of cells.

Additionally, the invention is directed to methods for determining normalized expression of a first gene in a cell or group of cells. The methods comprise creating the microarray described above, where the mixture of cDNA in at least one spot substantially quantitatively represents the entire mRNA population in the cell or group of cells; obtaining a first probe comprising a nucleic acid or mimetic complementary to at least a portion of the cDNA of the first gene, where the first probe further comprises a first detectable label; obtaining a second probe comprising a nucleic acid or mimetic complementary to at least a portion of the cDNA of a first housekeeping gene in the cells of interest, where the second probe further comprises a second detectable label; applying the first probe and the second probe to the microarray under conditions and for a time sufficient to allow specific hybridization of the first probe to the cDNA of the first gene and the second probe to the cDNA of the housekeeping gene; washing the microarray to remove probes that are not specifically hybridized to the microarray spots; quantifying the first detectable label from the first probe specifically hybridized to the gene of interest; quantifying the second detectable label from the second probe specifically hybridized to the housekeeping gene; and determining a ratio of the quantity of the first detectable label in relation to the second detectable label, wherein that ratio is the normalized expression of the first gene in the cell or group of cells.

The invention is additionally directed to methods of determining the difference in normalized expression of a first gene between a first cell or group of cells and a second cell or group of cells. The methods comprise creating the above-described microarray, where the microarray comprises a first spot comprising a first mixture of cDNA molecules, the first mixture of cDNA molecules proportional and complementary to a mixture of mRNA substantially quantitatively representing the mRNA population from the first cell or group of cells; and a second spot comprising a second mixture of cDNA molecules, the second mixture of cDNA molecules proportional and complementary to a second mixture of mRNA substantially quantitatively representing the mRNA population from the second cell or group of cells; obtaining a first probe comprising a nucleic acid or mimetic complementary to at least a portion of the cDNA of the first gene, wherein the first probe further comprises a first detectable label; obtaining a second probe comprising a nucleic acid or mimetic complementary to at least a portion of the cDNA of a housekeeping gene in the cells of interest, wherein the second probe further comprises a second detectable label; applying the first probe and the second probe to the microarray under conditions and for a time sufficient to allow specific hybridization of the first probe to the cDNA of the first gene and the second probe to the cDNA of the housekeeping gene; washing the microarray to remove probes that are not specifically hybridized to the microarray spots; quantifying, at the first spot and the second spot, the first detectable label from the first probe specifically hybridized to the gene of interest; quantifying, at the first spot and the second spot, the second detectable label from the second probe specifically hybridized to the housekeeping gene; determining a ratio of the quantity of the first detectable label in relation to the second detectable label at the first spot, wherein that ratio is the normalized expression of the first gene in the first cell or group of cells; determining a ratio of the quantity of the first detectable label in relation to the second detectable label at the second spot, wherein that ratio is the normalized expression of the first gene in the second cell or group of cells; and determining the difference in the expression of the first gene in the first cell or group of cells to the expression of the first gene in the second cell or group of cells.

The inventors have also discovered that microarrays can be useful for detecting short RNA molecules, such as siRNA or miRNA. Thus, in additional embodiments, the invention is directed to microarrays comprising a substrate, the microarray further comprising a plurality of spots, each spot affixed at identifiable locations on the surface of the substrate, wherein each spot comprises a mixture of short RNA molecules less than 80 bases long, or DNA molecules complementary to the short RNA molecules, the short RNA molecules from a cell or group of cells.

The invention is further directed to microarrays comprising a substrate, where the microarrays further comprise a plurality of spots, each spot affixed at identifiable locations on the surface of the substrate, where each spot comprises a known short RNA or DNA complementary to the short RNA.

Additionally, the invention is directed to methods of determining the presence of a short RNA of interest in a cell or group of cells. The methods comprise extracting and isolating RNA that is less than 80 bases long from the cell or group of cells; affixing the isolated RNA, or DNA complementary to the isolated RNA, to a first identifiable location on the surface of a substrate; obtaining a first probe comprising a nucleic acid or mimetic complementary to at least a portion of the short RNA of interest, wherein the first probe further comprises a first detectable label; applying the first probe to the microarray under conditions and for a time sufficient to allow specific hybridization of the first probe to the isolated RNA or complementary DNA on the surface of the substrate; washing the microarray to remove probes that are not specifically hybridized to the microarray spots; and determining whether the first detectable label is present at the identifiable location, where the presence of the detectable label at the identifiable location indicates that the short RNA was present in the cell or group of cells.

The invention is also directed to additional methods of determining the presence of a short RNA of interest in a cell or group of cells. The methods comprise extracting and isolating RNA that is less than 80 bases long from the cell or group of cells; labeling the isolated RNA, or DNA complementary to the isolated RNA, with a detectable label; obtaining the microarray described above comprising spots comprising a known short RNA or DNA complementary to the short RNA, where at least one of the spots is the short RNA of interest; applying the labeled RNA or complementary DNA to the microarray under conditions and for a time sufficient to allow specific hybridization of the first probe to the isolated RNA or complementary DNA on the surface of the substrate; washing the microarray to remove labeled RNA or complementary DNA that is not specifically hybridized to the microarray spots; and determining whether the first detectable label is present at the identifiable location comprising the short RNA or complementary DNA of interest, where the presence of the detectable label at the identifiable location indicates that the short RNA was expressed in the cell or group of cells.

### BRIEF DESCRIPTION OF THE DRAWINGS

FIG. 1 is diagrams providing an overview of REM technology. Panel A illustrates a probe preparation protocol starting with PCR using forward and reverse gene specific primers linked to a T7 promoter. T7 RNA polymerase produces an antisense RNA (blue line), and then reverse transcriptase produces a sense strand Cy3 or Cy5 labeled cDNA probe (Magenta plus red or green Cy dye). The Cy3 and Cy5 probes are made single stranded with RNases and then mixed prior to REM hybridization. Panel B illustrates a preferred embodiment of REM production and processing. Total RNA from tissues or cells serves as template for reverse transcriptase to synthesize a cDNA primed by oligo-dT or a SMART™ cDNA. CDNAs are printed on Corning GAP slides. Hybridization is carried out with mixed Cy3 and Cy 5 probes, in a humidified hybridization chamber followed by washing, scanning, and processing of the data using custom made scripts in a Linux operating system.

FIG. 2 is a computer image and graph of results from an REM analysis of albumin expression. Panel A shows organ specific hybridization of albumin to liver cDNA. A mouse organ REM was hybridized with Cy 5 labeled mouse albumin and Cy3 labeled mouse GAPDH probes. The combined computer image shows red for liver cDNA spots and green spots for all other organs. Panel B is a graph showing the sorting of liver specific albumin expression according to sex and genotype of donor mouse.

FIG. 3 is a computer image of REM hybridization of a set of standard liver cDNA mixes containing increasing amounts of bacterial LysA antisense cDNA. Panel A shows LysA abundance varying from approximately 9 to 9100 copies LysA cDNA per cell equivalent (left vertical labels×10³). Mixtures of cDNAs were printed at 400 or 800 pg/spot (right vertical labels). Mouse LysA was labeled with Cy3 (green) and mouse GAPDH with Cy5 (red), and the green image corresponds to high LysA. Panel B shows a dye reversal experiment, where mouse LysA was labeled with Cy 5 and mouse GAPDH with Cy 3, and high LysA is a red image.

FIG. 4 is graphs of standard curves for hybridization of increasing bacterial LysA gene versus constant genes GAPDH (encoding glyceraldehyde-3-phosphate dehydrogenase), CEBPα (encoding CCAAT/enhancer binding protein (C/EBP)), or albumin in liver cDNA mixes. Panel A shows the ratio of the LysA fluorescence signal intensity versus the GAPDH signal intensity is plotted as the log₂ of LysA/GAPDH fluorescence intensities (Y axis) derived from experiment shown in FIG. 3B. Two fold increases in the LysA abundance in the liver cDNA are plotted on the X axis as the log₂ of the LysA copy number per cell equivalent. The log₂ values on the X axis represent the following LysA copy numbers per liver cell equivalent of cDNA, log_{2.}2=4, 3.1=9, 4.1=18, 5.1=36, etc. CDNA mixtures were printed at two densities, either 400 pg total liver cDNA per spot (Diamonds), or 800 pg liver cDNA per spot (X's). 800 pg spots represent approximately 4,000 cell equivalents of liver cDNA. Panels B and C compare the use of the three reference human genes GAPDH, albumin or CEBPα, versus the spiked Lys A gene at the abundances stated in panel A.

FIG. 5 is a graph of a comparison of REM technology with quantitative Real Time PCR (RT-PCR). REM data (diamonds); Quantitative RT-PCR reaction (circles). Left Y axis: log₂ of the δCt value for LysA concentration by Real Time PCR. Right Y axis: log₂ of the Ratio of LysA/GAPDH fluorescence intensities for standard mixes from FIG. 4A. X axis; log₂ of the LysA cDNA copy number per spot.

FIG. 6. Panel A shows the combined fluorescence image of a REM hybridized simultaneously with Red (MYC) and Green (b2M) probes. Shown is an image from a segment of an REM containing SMART cDNA samples of paired tumor/normal tissues. Horizontal rows: Images of four replicate sets of each tumor/normal pair (8 spots/row). Vertical columns: Twelve tumor/normal pairs printed at either (a) 800 pg, or (b) 400 pg, or (c) 200 pg, or (d) 100 pg SMART™-prepared cDNA/spot. Panel B shows a histogram of MYC expression in lung tumor and normal samples using β₂-microglobulin (b2M) as the reference gene. Error bars represent standard deviation determined from four measurements of the MYC/b2M ratio for each sample on the REM. The δC_{T} values determined by real time PCR are above each tumor/normal pair. A negative δC_{T} value means MYC was higher in tumor tissue compared to companion normal tissue by quantitative real time PCR analysis. δC_{T} represents the difference in the number of real time PCR cycles to reach maximum rate of amplification between tumor and normal paired samples.

FIG. 7 is graphs of experimental results showing the stability of gene expression ratios with different reference probes. These are the results of hybridization of four independent REMs with a test gene glutathione peroxidase (GP) and the following sets of reference probes: Panel A: β-actin; Panel B: ubiquitin; Panel C: 23 kDa basic protein; Panel D: mixture of probes in A-C. Solid Bars-Normal tissue; Hatched bars—Tumor tissue.

FIG. 8 is graphs of experimental results showing the stability of gene expression ratios at different spotting densities with the same reference probe. These are results of hybridizations with the same set of five kidney tumor/normal pairs printed at three different densities: Panel A: 100 pg/spot; Panel B: 200 pg/spot; Panel C: 400 pg/spot.

FIG. 9 is graphs of experimental results showing a standard curve for albumin expression in mixes of liver and kidney RNAs. Liver RNA was increased by 20% increments from 0 to 100% in RNA mixes that were used to synthesize cDNAs for printing on REMs. Albumin probe was labeled with Cy 5 (Red) and Gapdh (Cy3). The correlation coefficient for linearity was 0.99

FIG. 10 shows a map of the alternatively spliced mRNAs of Mxi1. Probes were prepared from the SRα, SRβ, and common exons marked in the figure.

FIG. 11 is graphs of experimental results showing organ and mouse specific differences in Mxi1 splice variant abundance. Panel A shows the results when REM6 was hybridized with SRβ and Common (Cy3) probes. The data are expressed as a ration of SR/common. Panel B shows the results when REM 6 hybridized simultaneously with SRα (Cy5) and Common (Cy3) probes and data are expressed as a ratio of SRα/common. Each bar represents a cDNA preparation for that specific organ from one mouse; thus, data from the brains of 6 mice is shown. Note the data from graphs A and B are from the same set of cDNAs printed on two REMs and hybridized to different probes.

FIG. 12 is graphs of experimental results showing the effects of genotype on Mxi1 splice variant expression with comparisons of SRα abundance in multiple organs from male mouse of an outbred strain (CD1) versus a male mouse of an inbred strain (C57B16). (Left) Differences determined using Mxi1 common exon as reference. (Right) Differences determined using GAPDH as the housekeeping gene reference.

FIG. 13 is a photograph and graphs of experimental results showing standard curves for the increase of mir122a probe hybridization with 20% increases in liver small RNA. Panel A shows merged Images of hybridized spots on microRNA REM. The left set of spots is of a microRNA REM hybridized with a Red mir1122 probe and green U6 housekeeping gene probe. The spots show a gradient from orange to green going down the rows. The right set of spots is of a microRNA REM hybridized with a Green mir122 probe and Red U6 probe. The spots show a gradient from green to red going down the rows. In both photographs, the spots across the columns in the same row looked identical, showing minimal variation among replications. Panel B shows a graph of the average signal intensities of mir122a and U6 probe hybridization for the left set of spot in A. Panel C shows a plot of the ratio of mir122a/U6 probe hybridization calculated from the intensities in panel B.

FIG. 14 is a graph of a microRNA gene array data showing differences in the hybridization of microRNAs from male and female liver to different microRNA genes. Mirh26b is most increased in male liver compared to female liver. The horizontal axis shows different microRNA genes.

FIG. 15 is a graph of experimental results showing differential hybridization of modified and standard oligonucleotides to a microRNA gene array. 122a LNA Ex is a sense strand oligonucleotide containing LNAs from Exiqon corporation. 122a+AM is a standard sense oligonucleotide with an amino modification at the N-terminus. 122a is a standard sense oligonucleotide (no modifications). Oligonucleotides were spotted at different densities shown on the X axis.

FIG. 16 is a graph of experimental results showing differential hybridization of modified and standard probes to a microRNA gene array. Mir92 LNA is an LNA-modified oligonucleotide from IDT corporation. Mir92 LNA Ex is an LNA-modified oligonucleotide from Exiqon corporation. Mir 92 AM is an amino modified oligonucleotide; Mir 92 is a standard sense oligonucleotide.

### DETAILED DESCRIPTION OF THE INVENTION

The present invention is based in part on the discovery that certain formats of microarrays and microarray assays provide unexpectedly accurate and reproducible measurements of expression of genes in a cell or group of cells, where the microarrays comprise spots of mixtures of cDNAs of mRNAs present in a cell or group of cells. This “reverse” format, where specific labeled probes of genes of interest are used to determine expression of those genes represented in the spots, is opposed to the more common microarray format, where each spot comprises a single sequence and gene expression in a sample is measured by probing the microarrays with labeled cDNA copies of the mRNA from the cells of interest.

As used herein, a microarray is a solid support (also known as a substrate) comprising spots, where the spots comprise nucleic acids affixed to the support.

Thus, in some embodiments, the invention is directed to microarrays comprising a nonporous support, the microarray further comprising a plurality of spots, each spot affixed at identifiable locations on the surface of the support, wherein each spot comprises a mixture of cDNA molecules, the cDNA mixture being complementary and substantially quantitatively proportional to a mixture of mRNA molecules present in a cell or group of cells.

The substrate can be any material known for this purpose. In preferred embodiments, where a light-detectable moiety such as a fluorescent moiety is used, the material is preferably transparent or a mirrored substrate, such as any polymers, available for this purpose, or, preferably, glass. Numerous brands of glass are available for this purpose.

Where the substrate is glass, any known pretreatment of the glass can be used to provide improved noncovalent or covalent binding capabilities over untreated glass. Examples include treatments to create surface amino, aldehyde or epoxy moieties, including the preferred silane compounds, or treatments with poly-L-lysine, hydrophobic polymers, nitrosylated polysaccharides, or metal (e.g., gold).

Before being utilized in an assay, the microarray may be pretreated, e.g., to denature the cDNA in the spots, making the cDNA single-stranded. In a preferred embodiment, the microarray is treated with UV light then heat.

The microarray can be any size, including the common 25 mm×75 mm standard microscope slide size.

The cDNA can be produced by any known method, e.g., polyA isolation of mRNA and rtPCR, or SMART™ DNA technology (BD Biosciences, Palo Alto, Calif.). In some preferred embodiments, the cDNA is synthesized using oligo dT primed reverse transcription, most preferably using an anchor-primed oligo dT primer with a single dA, dC, dG or dT nucleotide at the 3′ end of the primer (see, e.g., Example 2).

In preferred embodiments, each spot comprises cDNA prepared from mRNA of 1000-8000 cell equivalents, and about 100-800 pg of cDNA. At these cell numbers, an mRNA can be detected at a level of about 2 copies per cell when either standard cDNA or SMART™ DNA technology is used. Thus, when the number of copies of an mRNA of interest is expected to be 2000 or more per cell, the amount of cDNA representing one cell can be used to make one spot.

CDNA derived from any prokaryotic, archaeal, or eukaryotic species can be used in the microarrays. Where the cells are eukaryotic cells, the mRNA is preferably polyA-mRNA. In other preferred embodiments, the cells represented by each spot are from one tissue or organ. The cell or groups of cells can also comprise a plant cell, or any animal cell, including a vertebrate cell, preferably a mammalian cell such as a rodent or human.

The spots on the microarrays can represent mRNA from a cell or group of cells of different species, to compare expression of genes of interest among different species. Alternatively, each spot on a microarray can represent the mRNA population from different tissues of the same species, either from the same individual, different individuals, or from pooled mRNA or cDNA from a more than one individual. In other aspects of these embodiments, the spots represent the mRNA from the same tissue of different individuals of the same species, e.g., individuals that were exposed to different environmental conditions, individuals that vary in disease state, or individuals that vary in developmental stage.

In other embodiments, the invention is directed to methods of making a microarray comprising a nonporous support. The methods comprise applying a plurality of spots to the support, where each spot is applied to an identifiable location on the surface of the support. In these methods, each spot comprises a mixture of cDNA molecules, the mixture of cDNA molecules being proportional to a mixture of mRNA complementary to the cDNA, and the mixture of mRNA substantially quantitatively representing the mRNA population from a cell or group of cells.

Thus, the microarrays produced by these methods are the microarrays described above. As such, all embodiments of the microarrays described above can be produced by these methods, e.g., utilizing a glass support that is coated with silane, and treating the microarray with UV light then heat to denature the cDNA on the support.

It is understood that the microarrays described above can be used to determine normalized expression of a gene in a cell or group of cells. The normalized expression is determined by using a labeled probe to the gene to quantify the cDNA on the microarray that hybridizes to the gene and normalizing that data with data determined on the same spot for a housekeeping gene.

As with the embodiments discussed above, the cDNA can be produced by any known method. In some preferred embodiments, the cDNA is synthesized using oligo dT primed reverse transcription, most preferably using an anchor-primed oligo dT primer with a single dA, dC, dG or dT nucleotide at the 3′ end of the primer (see, e.g., Example 2).

The invention is further directed to methods for determining normalized expression of a first gene in a cell or group of cells. The methods comprise
creating the microarray described above, where the mixture of cDNA in at least one spot substantially quantitatively represents the entire mRNA population in the cell or group of cells,
obtaining a first probe comprising a nucleic acid or mimetic complementary to at least a portion of the cDNA of the first gene, where the first probe further comprises a first detectable label,
obtaining a second probe comprising a nucleic acid or mimetic complementary to at least a portion of the cDNA of a first housekeeping gene in the cells of interest, where the second probe further comprises a second detectable label,
applying the first probe and the second probe to the microarray under conditions and for a time sufficient to allow specific hybridization of the first probe to the cDNA of the first gene and the second probe to the cDNA of the housekeeping gene,
washing the microarray to remove probes that are not specifically hybridized to the microarray spots,
quantifying the first detectable label from the first probe specifically hybridized to the gene of interest,
quantifying the second detectable label from the second probe specifically hybridized to the housekeeping gene, and
determining a ratio of the quantity of the first detectable label in relation to the second detectable label, wherein that ratio is the normalized expression of the first gene in the cell or group of cells.

The detectable label in these embodiments can be any label that can be quantitatively measured when hybridized to the probes spotted on the microarray. Nonlimiting examples of useful probe labels are proteins such as green fluorescent protein, antibodies or antigen binding regions of antibodies (e.g., an FAb region), or enzymes for which there is a substrate that the enzyme converts into a detectable product, such as peroxidase or alkaline phosphatase; a moiety that can be bound by a labeled binding agent, where the binding agent is preferably multivalent, e.g. a biotin moiety; a fluorescent moiety; an antigen such as a hapten that can be detected using a labeled antibody or antibody binding site, e.g., the hapten digoxygenin; a spin label; or a radioactive moiety. Methods of labeling probes with any of the above labels are known in the art. In preferred embodiments, the detectable label is a fluorescent label. Nonlimiting examples include Cy2, Cy3, Cy5, Cy7 (Amersham Biosciences, Piscataway, N.J.); fluorescein or rhodamine derivatives; green fluorescent protein; and phycobiliproteins.

An important aspect of these embodiments includes the use of a housekeeping gene as an internal standard to normalize variations from spot to spot, from experiment to experiment, and from microarray to microarray. Thus, the housekeeping gene expression can be used to normalize against variations in cell numbers extracted between samples. The housekeeping gene is hybridized along with the test probe and is detected using a detectable label on the probe for the housekeeping gene that can be quantitatively distinguished from the detectable label on the probe used for the gene of interest. The housekeeping gene can be any gene that is expected to have substantially the same per-cell expression among experiments that are compared and replications within an experiment. As used herein, “substantially the same expression” means that the per-cell values are not statistically significant at P<0.05. Examples of useful housekeeping genes include GAPDH, β₂-microglobulin, ubiquitin, β-actin, and 23 kD basic protein. The skilled artisan can identify the most appropriate housekeeping gene for the samples utilized without undue experimentation. A probe for a second housekeeping gene can also be included with the probe for the first housekeeping gene, either comprising the same or a different detectable label as the probe for the first housekeeping gene.

When optimized using routine methods known in the art, these methods are generally quite sensitive, and can detect expression of the first gene present in the cells at two copies per cell equivalent.

In some preferred embodiments, the microarray is further treated with UV light then heat before applying the probes, to denature the cDNA in the spots, allowing more efficient hybridization of the probes to the cDNA complementary to the probes.

In order to assure that the cDNA detected with the probes is quantitatively representative of the mRNA from the cell, it is preferred that the first probe is complementary to a unique segment of the 3′ end of the first gene and the second probe is complementary to a unique segment of the 3′ end of the housekeeping gene. In other preferred embodiments, each probe is in sense orientation.

The labeled probes can be synthesized by any means known in the art, including for example, RNA polymerase transcription of the appropriate portion of the cDNA, then reverse transcription comprising the incorporation of a nucleotide comprising the detectable label (i.e., the Eberwine procedure [Eberwine, 1996]), nick translation, PCR amplification using a labeled deoxyribonucleotide, RNA polymerase transcription using a labeled ribonucleotide, etc. The skilled artisan can determine the best method of probe synthesis for any application without undue experimentation.

It is expected that the microarray can be stripped of bound probe after the assay is performed, and then reprobed with other labeled probes. If stripping and reprobing is desired, it is preferred that the cDNAs are covalently attached to the substrate.

These methods can be utilized to determine expression of a second gene in the sample spotted on the microarray, e.g., to compare the expression of the first gene to the second gene. This is accomplished by taking any of the above methods and further:
obtaining a third probe comprising a nucleic acid or mimetic complementary to at least a portion of the cDNA of a second gene, where the third probe further comprises a third detectable label;
applying the third probe to the microarray under conditions and for a time sufficient to allow specific hybridization of the third probe to the CDNA of the second experimental gene.
washing the microarray to remove any third probe that is not specifically hybridized to the microarray spots,
quantifying the third detectable label from the third probe specifically hybridized to the gene of interest, and
determining a ratio of the quantity of the third detectable label in relation to the second detectable label, wherein that ratio is the normalized expression of the second gene in the group of cells.

Additional genes can be quantified by analogous methods, i.e., probing the microarray with a probe to the additional genes, where each probe is labeled with a label that can be distinguished from the labels used on the probe for the first or second gene.

In preferred embodiments, the third probe is applied, washed and quantified simultaneously with the first probe and the second probe.

These methods can generally detect differences in expression between the two genes when a difference in normalized expression of the first gene to the second gene of 40% can be detected. In preferred embodiments, a difference in normalized expression of the first gene to the second gene of 30% can be detected; in more preferred embodiments, a difference in normalized expression of the first gene to the second gene of 25% can be detected. In the most preferred embodiments, a difference in normalized expression of the first gene to the second gene of 20% can be detected.

These methods can be used to detect differences in expression of any two genes now known or later discovered, whether from eukaryotes, prokaryotes, or archaea. The methods are particularly useful for comparing expression of splice variants of the same gene (see Example 3).

The invention is additionally directed to methods of determining the difference in normalized expression of a first gene between a first cell or group of cells and a second cell or group of cells. The methods comprise
creating the above-described microarray, where the microarray comprises a first spot comprising a first mixture of cDNA molecules, the first mixture of cDNA molecules proportional and complementary to a mixture of mRNA substantially quantitatively representing the mRNA population from the first cell or group of cells; and a second spot comprising a second mixture of cDNA molecules, the second mixture of cDNA molecules proportional and complementary to a second mixture of mRNA substantially quantitatively representing the mRNA population from the second cell or group of cells;
obtaining a first probe comprising a nucleic acid or mimetic complementary to at least a portion of the cDNA of the first gene, wherein the first probe further comprises a first detectable label;
obtaining a second probe comprising a nucleic acid or mimetic complementary to at least a portion of the cDNA of a housekeeping gene in the cells of interest, wherein the second probe further comprises a second detectable label;
applying the first probe and the second probe to the microarray under conditions and for a time sufficient to allow specific hybridization of the first probe to the cDNA of the first gene and the second probe to the cDNA of the housekeeping gene;
washing the microarray to remove probes that are not specifically hybridized to the microarray spots;
quantifying, at the first spot and the second spot, the first detectable label from the first probe specifically hybridized to the gene of interest;
quantifying, at the first spot and the second spot, the second detectable label from the second probe specifically hybridized to the housekeeping gene;
determining a ratio of the quantity of the first detectable label in relation to the second detectable label at the first spot, wherein that ratio is the normalized expression of the first gene in the first cell or group of cells;
determining a ratio of the quantity of the first detectable label in relation to the second detectable label at the second spot, wherein that ratio is the normalized expression of the first gene in the second cell or group of cells; and
determining the difference in the normalized expression of the first gene in the first cell or group of cells to the normalized expression of the first gene in the second cell or group of cells.

These methods are entirely analogous to the other invention methods described above. The expression of the gene of interest between the two samples can be analyzed by any known method, as can be determined without undue experimentation by the skilled artisan. A preferred method is described in Livak & Schmittgen, 2001.

These methods can generally detect differences in expression between the two genes when a difference in normalized expression of the first gene to the second gene of 40% can be detected. In preferred embodiments, a difference in normalized expression of the first gene to the second gene of 30% can be detected; in more preferred embodiments, a difference in normalized expression of the first gene to the second gene of 25% can be detected. In the most preferred embodiments, a difference in normalized expression of the first gene to the second gene of 20% can be detected.

These methods can be used to detect differences in expression of any two genes now known or later discovered, whether from eukaryotes, prokaryotes, or archaea. The methods are particularly useful for comparing expression of splice variants of the same gene.

The expression of the gene of interest can be compared between any two groups of cells, e.g., where the first group of cells and the second group of cells are from different tissues in the same organism or where the first group of cells and the second group of cells are from the same tissue of two different organisms; wherein the two different organisms are from the same species, for example where the two different organisms are different genotypes, or the same genotype subjected to different environmental conditions or at different developmental stages.

The inventors have also discovered that microarrays can be useful for detecting short RNA molecules. As used herein, a short RNA is an RNA that is less than 80 nucleotides in length. These short RNAs can be double stranded or single stranded. Preferred, but nonlimiting examples include siRNA and miRNA, which can specifically interfere with transcription or translation of a gene. Thus, in additional embodiments, the invention is directed to microarrays comprising a substrate, the microarray further comprising a plurality of spots, each spot affixed at identifiable locations on the surface of the substrate, wherein each spot comprises a mixture of short RNA molecules less than 80 bases long, or DNA molecules complementary to the short RNA molecules, from a cell or group of cells. These microarrays are useful, e.g., for determining the presence and quantity of short RNAs in a cell or group of cells by probing the microarrays with labeled known short RNAs. In preferred embodiments, the short RNA is less than 50 nucleotides long; more preferably, the short RNA is less than 40 nucleotides long; even more preferably, the short RNA is less than about 30 nucleotides long. In most preferred embodiments, the short RNA is less than 25 nucleotides long, e.g., 20-23 nucleotide long siRNA or miRNA. The short RNAs on the microarray spots can be any short RNA present in the cell or group of cells, including short RNAs implicated in controlling gene expression (e.g., siRNA or miRNA), as well as any other short RNA, including, e.g., inactive products of nuclease digestion of longer mRNAs or viral sequences.

In these embodiments, any substrate including porous (e.g., membranes), and nonporous substrates can be used. As in embodiments described above, the substrate is preferably glass, particularly silanized glass.

The invention is also directed to microarrays comprising a substrate, the microarrays further comprising a plurality of spots, each spot affixed at identifiable locations on the surface of the substrate, where each spot comprises a known short RNA or DNA complementary to the short RNA. These microarrays are also useful for determining the presence of short RNAs in a cell or group of cells, by probing the microarrays with labeled RNA, preferably small RNA (e.g., less than 100 nucleotides or 80 nucleotides or 50 nucleotides or 40 nucleotides or 25 nucleotides) or cDNA complementary to the RNA, extracted or amplified from a cell of group of cells.

Additionally, the invention is directed to methods of determining the presence of a short RNA of interest in a cell or group of cells, using the microarrays for detecting short RNAs described above. In some embodiments, the methods comprise
extracting and isolating RNA that is less than 80 bases long from the cell or group of cells;
affixing the isolated RNA, or DNA complementary to the isolated RNA, to a first identifiable location on the surface of a substrate;
obtaining a first probe comprising a nucleic acid or mimetic complementary to at least a portion of the short RNA of interest, wherein the first probe further comprises a first detectable label;
applying the first probe to the microarray under conditions and for a time sufficient to allow specific hybridization of the first probe to the isolated RNA or complementary DNA on the surface of the substrate;
washing the microarray to remove probes that are not specifically hybridized to the microarray spots; and
determining whether the first detectable label is present at the identifiable location,
wherein the presence of the detectable label at the identifiable location indicates that the short RNA was expressed in the cell or group of cells.

These methods are useful for detecting any short RNA, including siRNA, and miRNA.

In preferred embodiments, the substrate is glass, preferably silanized glass.

As with other methods described above, it is preferred that the microarray also be probed with a labeled probe for a short RNA that can be expected to be quantitatively consistent among different samples, in order to have a standard to normalize the results among samples or microarrays. Such quantitatively consistent short RNAs can be determined for any organism or tissue without undue experimentation. In preferred embodiments, the first probe comprises at least one locked nucleic acid monomer.

These methods can be used to quantify the short RNA on the microarray spot, by
affixing a known quantity of a DNA or RNA standard to a second identifiable location on the surface of the substrate; and
obtaining a second probe comprising a nucleic acid or mimetic complementary to the DNA or RNA standard, wherein the second probe further comprises a second detectable label;
and before the washing step, applying the second probe to the microarray under conditions and for a time sufficient to allow specific hybridization of the second probe to the DNA or RNA standard on the surface of the substrate;
and after the washing step, quantifying the first detectable label and the second detectable label
then determining a ratio of the quantity of the first detectable label in relation to the second detectable label, wherein that ratio is the expression of the first short RNA in the cell or group of cells.

The invention is also directed to other methods of determining the presence of a short RNA of interest in a cell or group of cells. The methods comprise
extracting and isolating RNA that is less than 80 bases long from the cell or group of cells;
labeling the isolated RNA, or DNA complementary to the isolated RNA, with a detectable label;
obtaining the microarray described above comprising spots having a known short RNA or DNA complementary to the short RNA, where at least one of the spots is the short RNA of interest;
applying the labeled RNA or complementary DNA to the microarray under conditions and for a time sufficient to allow specific hybridization of the first probe to the isolated RNA or complementary DNA on the surface of the substrate;
washing the microarray to remove labeled RNA or complementary DNA that is not specifically hybridized to the microarray spots; and
determining whether the first detectable label is present at the identifiable location comprising the short RNA or complementary DNA of interest,
wherein the presence of the detectable label at the identifiable location indicates that the short RNA was expressed in the cell or group of cells.

Preferred embodiments of the invention are described in the following examples. Other embodiments within the scope of the claims herein will be apparent to one skilled in the art from consideration of the specification or practice of the invention as disclosed herein. It is intended that the specification, together with the examples, be considered exemplary only, with the scope and spirit of the invention being indicated by the claims, which follow the examples.

### EXAMPLE 1

### RNA Expression Microarrays (REMs), a High Throughput Research Tool to Detect Differences in Gene Expression in Diverse Biological Samples

### Example Summary

CDNA microarrays screen expression of thousands of genes from one tissue simultaneously (Brown and Botstein, 1999; Lewin, 1997; Velculescu et al., 1995; Schena et al., 1995; 1996; Iyer et al., 1999; Plescia et al., 2001) and have identified new candidate oncogenes (Bittner et al., 2000; Yu et al., 2004; Robert et al., 2004; Kitahara et al., 2001; Allzaeh et al., 2000; Mathiassen et al., 2001; Kaminski et al., 2000). However, analysis of hundreds of specimens from patients in different stages of disease is needed to establish the diagnostic, prognostic and therapeutic importance of emerging cancer genes. We developed an array-based technique called RNA Expression Microarrays (REMs) that facilitates gene expression analysis in a quantitative, high-throughput manner. REMs contain individually spotted complex cDNAs synthesized from the polyA mRNA of cells and tissues. Simultaneous hybridization of REMs with test and reference genes enables precise, internally normalized, measurement of gene expression. Prototype REMs demonstrate sensitivity down to two to four copies of mRNA per cell and accuracy equivalent to quantitative real time PCR. REM technology detected organ specific expression and MYC over-expression in a panel of tumor samples.

### Introduction

We have developed RNA Expression Microarrays (REMs) that accomplish this goal. REMs are produced by isolating total RNA from cells/tissues and synthesizing a cDNA copy of the polyA⁺ mRNAs in the sample. The cDNA to be printed on glass microscope slides can either be single stranded antisense cDNA produced by reverse transcription, or the cDNA can be rendered double stranded by amplification using SMART™ DNA technology (Chenchik et al., 1998; Zhu et al., 2001; Zhumabayeva et al., 2001).

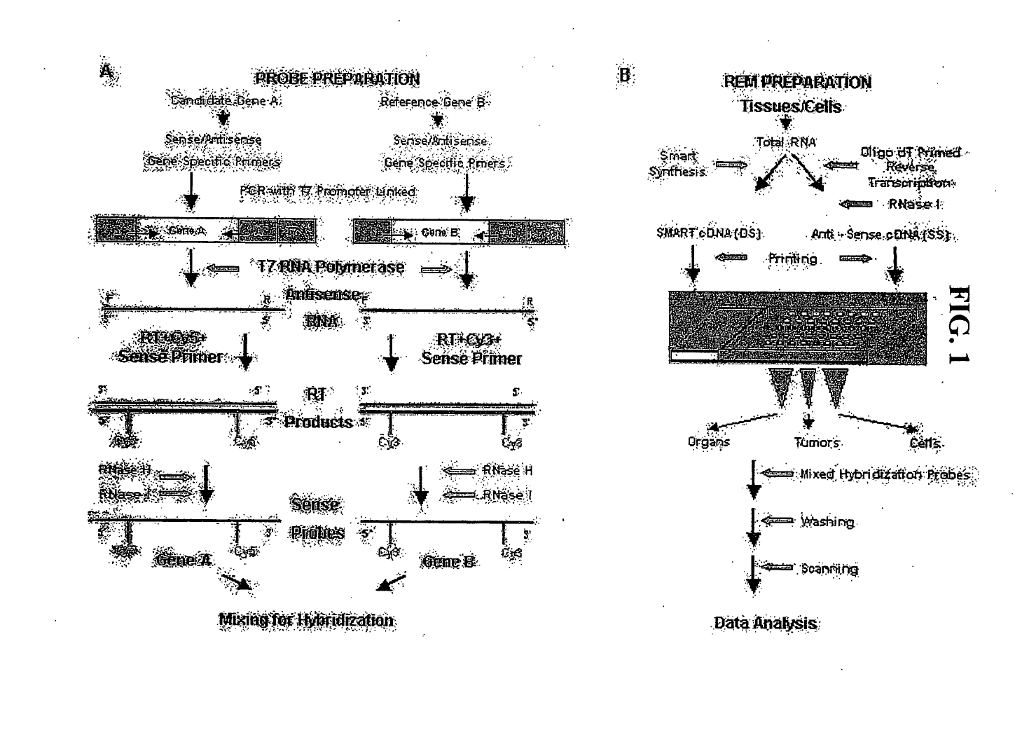

REMs are a reverse format microarray, in which the high complexity “target” is bound to a solid support and differentially labeled probes from at least two genes are hybridized to the target (FIG. 1). This allows one probe, to a housekeeping gene, to serve as an internal normalization control for sample loading. We hypothesized that the kinetics of hybridization for REMs should be similar to that of cDNA microarrays (Shalon, 1995), except that the hybridization would be driven by the high concentration of probes in solution above the bound nucleic acids. During development of the technology we tested several different solid supports and different densities of sample printing per spot. We tested total RNAs, poly A⁺ RNAs, aRNAs (Eberwine, 1996), single stranded cDNAs and SMART cDNAs (Chenchil et al., 1998). While RNA samples were successfully hybridized, they were very sensitive to RNase degradation. CDNAs were found to be a much more stable substrate for printing and hybridization. Therefore, in this report we only present data using our current REM protocol that involves printing cDNAs on silane coated glass microscope slides at cDNA spotting densities representing approximately 1000 to 4000 cell equivalents per spot.

REMs are hybridized simultaneously with a test probe, usually labeled with Cy5 (Red) fluorescent dye and a housekeeping gene probe, usually labeled with a Cy3 (green) fluorescent dye (FIG. 1). Hybridization signals are measured with a laser scanner (22), and fluorescence data are processed using gene pix software (Axon, Garden City, Calif.). Data sorting and analysis is carried out using customized computer scripts written using a Linux operating system, and plotted using Gnu Plot software.

### Results and Discussion

Our initial test of REM Technology was to determine whether we could detect organ specific hybridization of test probes. We decided to use albumin as an example of an abundant liver specific probe, Hnf4 as a liver preferential transcription factor probe, and Insulin-like growth factor binding protein-1 (IGFBP-1) as a gene weakly expressed in the liver. Cy5 labeled albumin, Hnf4 and IGFBP-1 probes were synthesized along with Cy3 labeled GAPDH probe. REMs were produced by printing single stranded antisense cDNAs from a set of mouse organs at a density/spot that represented cDNA from 4000 cells (Sambrook and Russell, 2001). In the case of liver, we printed cDNAs from six different livers, representing one CD1 male, two C57B1/6 males, and one CD1 female and two C57B1/6 females. Each cDNA sample was printed in quadruplicate. Thus, the overall ratio of albumin/GAPDH for liver was calculated from forty-eight quantitative fluorescence measurements (six liver samples, 4× spotting, two probes simultaneously hybridized). Other mouse organs were also represented by multiple samples and each was also quadruplicate spotted.

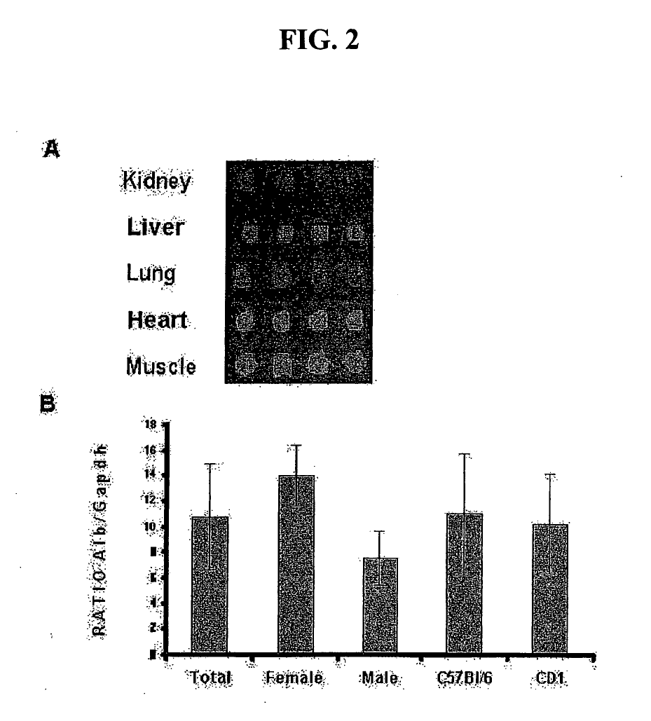

We hybridized a REM with Cy5 labeled albumin plus Cy3 labeled GAPDH probes. The hybridization revealed a set of strongly red spots for liver and green spots for all the other organs, as expected. Examples of hybridized spots, viewed as the combined Cy5-Cy3 computer image, are shown in FIG. 2A. Only the spots corresponding to liver extracts were red; the other spots were green. Using a customized computer script in Linux, we calculated the ratio of the albumin signal versus GAPDH for the entire set of mouse organs (Table 1). The ratio for albumin was 10.76±4.08 for liver, whereas the average ratio for the other organs was 0.25±0.1, clearly demonstrating strong liver specific expression.

TABLE 1

| | RATIO Gene/Gapdh ± SDEV | | |
|---|---|---|---|
| Tissue | Alb | Hnf4 | Igfbp1 |
| Adipose | 0.17 ± 0.02 | 0.34 ± 0.03 | 0.12 ± 0.01 |
| Adrenal gland | 0.36 ± 0.2 | 0.42 ± 0.03 | 0.14 ± 0.02 |
| Bladder | 0.36 ± 0.45 | 0.46 ± 0.1 | 0.15 ± 0.01 |
| Brain | 0.45 ± 0.03 | 0.36 ± 0.07 | 0.1 ± 0.02 |
| Cerebellum | 0.15 ± 0.03 | 0.36 ± 0.04 | 0.12 ± 0.01 |
| Colon | 0.18 ± 0.06 | 0.43 ± 0.08 | 0.11 ± 0.04 |
| Duodenum | 0.23 ± 0.06 | 0.4 ± 0.1 | 0.12 ± 0.02 |
| Epididymis | 0.2 ± 0.02 | 0.53 ± 0.01 | 0.16 ± 0.01 |
| Heart | 0.23 ± 0.03 | 0.33 ± 0.05 | 0.15 ± 0.06 |
| Intestine | 0.13 ± 0.02 | 0.38 ± 0.05 | 0.09 ± 0.02 |
| Kidney | 0.17 ± 0.07 | 0.42 ± 0.08 | 0.12 ± 0.03 |
| Liver | 10.76 ± 4.08 | 1.04 ± 0.23 | 0.14 ± 0.04 |
| Lung | 0.38 ± 0.11 | 0.47 ± 0.07 | 0.2 ± 0.08 |
| Mammary | 0.58 ± 0.47 | 0.43 ± 0.01 | 0.1 ± 0 |
| Muscle | 0.1 ± 0.1 | 0.26 ± 0.08 | 0.04 ± 0.03 |
| Ovary | 0.23 ± 0 | 0.42 ± 0.01 | 0.13 ± 0.03 |
| Pancreas | 0.22 ± 0.02 | 0.42 ± 0.06 | 0.51 ± 0.09 |
| Penial gland | 0.22 ± 0.02 | 0.43 ± 0 | 0.17 ± 0.01 |
| Salivary | 0.29 ± 0.03 | 0.36 ± 0.09 | 0.22 ± 0.02 |
| Skin | 0.19 ± 0.01 | 0.34 ± 0.12 | 0.11 ± 0.07 |
| Spleen | 0.24 ± 0.05 | 0.45 ± 0.1 | 0.42 ± 0.19 |
| Stomach | 0.29 ± 0.1 | 0.5 ± 0.06 | 0.15 ± 0.05 |
| Testis | 0.25 ± 0.04 | 0.5 ± 0.03 | 0.15 ± 0.01 |
| Thymus | 0.2 ± 0.03 | 0.41 ± 0.01 | 0.11 ± 0.01 |
| Uterus | 0.21 ± 0.09 | 0.42 ± 0.03 | 0.14 ± 0.04 |

The standard deviation for liver specific hybridization was very high, suggesting an unexpectedly high level of variability in albumin expression between the different liver samples. To investigate this, we sorted the liver data according to sex, or genotype, of the mice from which the liver samples were taken. By this analysis, we observed no difference due to mouse genotype; however, we observed a significant increase in albumin expression in female liver cDNAs (FIG. 2B). This makes sense biologically since an important function of albumin is as a serum carrier protein for estrogen in females (Andre et al., 2003). These data demonstrate that REM technology can reveal new information about gene expression differences due to sex and/or genotype.

A second mouse organ REM was hybridized with Hnf4 plus GAPDH. Analysis of the hybridization again revealed liver preferential expression as expected along with significant expression in all other organs tested (Table 1). Hybridization of a third mouse organ REM with IGFBP-1 and GAPDH probes revealed the strongest hybridization in the pancreas and spleen, in contrast to liver expression (Table 1).

It is not possible to be certain that every spot on a REM is equally loaded with cDNA. Therefore, as stated above, it is essential to have an internal housekeeping gene control. The data in Table 2 were generated from a separate REM printing, in which several cDNA samples including muscle and brain were overloaded. Thus, for example, albumin hybridization was very high in the muscle cDNA. However, after normalization with GAPDH, the ratio for albumin expression versus GAPDH in muscle is very low (0.08) as was expected. These data demonstrate that test gene expression can be accurately normalized against an internal reference for quantitative analysis even when a sample is extensively overloaded.

TABLE 2

| | GAPDH | ALBUMIN | ALB/GAPDH |
|---|---|---|---|
| ORGAN | INTENSITY | INTENSITY | (ratio) |
| Kidney | 781 ± 53 | 259 ± 19 | 0.33 ± 02 |
| Liver | 743 ± 53 | 3,971 ± 229 | 5.36 ± 0.26 |
| Lung | 1,153 ± 82 | 392 ± 28 | 0.34 ± 0.04 |
| Brain | 16,272 ± 1,093 | 2,808 ± 284 | 0.17 ± 0.01 |
| Intestine | 2,322 ± 38 | 383 ± 43 | 0.16 ± 0.02 |
| Heart | 5,597 ± 138 | 783 ± 26 | 0.14 ± 0 |
| Muscle | 13,717 ± 508 | 1,118 ± 101 | 0.08 ± 0 |

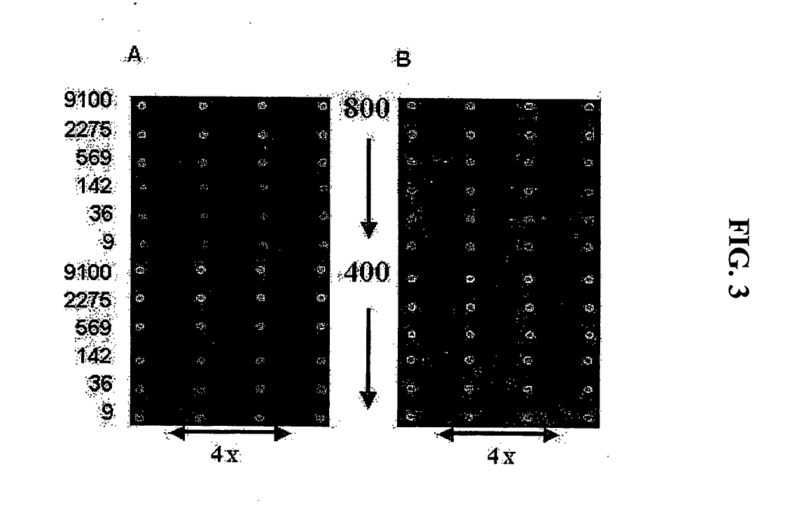

We next set up an experiment to determine the accuracy of REM technology for detecting rare transcripts in a complex liver cDNA mixture. We prepared artificial cDNA mixes in which we spiked a liver cDNA preparation with various levels of a bacterial gene (LysA). These mixes were printed on silane coated glass microscope slides at 400 pgs or 800 pg of liver cDNA per spot (Sambrook and Russell, 2001). Four hundred pg cDNA represents the cDNA from approximately 2000 hepatocytes and the levels of spiked LysA cDNA ranged from approximately 9,000 copies per cell equivalent (i.e., 1.8×10⁷ copies per 400 pg sample) to approximately 2 copies per cell equivalent (4×10⁴ copies per 400 pg sample). The results from a set of standard mixes, printed in quadruplicate and hybridized simultaneously with a Green (Cy3) LysA probe and a Red (Cy5) GAPDH reference probe, are shown in FIG. 3A. The computer combined image shows that spots containing the high level of LysA are green and those with a low or undetectable LysA level are Red, representing solely GAPDH reference gene hybridization. A dye reversal experiment revealed a reversed pattern of colored spots, demonstrating the accuracy and reproducibility of the hybridization and detection technology (FIG. 3B).

Quantitative analysis of the hybridization signals from FIG. 3A allowed us to calculate a ratio for the LysA gene versus GAPDH across the standard curve of 400 pg spots (FIG. 4). These data showed an increasing ratio from 2 to 9000 copies of LysA per liver cell cDNA equivalent. A duplicate set of mixes printed at 800 pg/spot produced a standard curve that was virtually identical to that obtained with the 400 pg/spot series (FIG. 4). Therefore, the ratio of test gene versus reference gene is independent of the density of spotting.

Three Standard REMs were also hybridized with LysA and either Albumin, GAPDH (encoding glyceraldehyde-3-phosphate dehydrogenase), CEBPα (encoding CCAAT/enhancer binding protein (C/EBP)). The ratio of LysA hybridization versus each of the reference genes was calculated across the dilution series and a series of standard curves were produced (FIG. 4b, 400 pg series of mixes). Use of CEBPα as reference produced a curve above that of GAPDH and the albumin reference produced a standard curve below that of GAPDH as predicted. These data demonstrated that relative gene ratios calculated with REMs were dependent upon both the level of the test gene and the reference gene. This same set of curves was duplicated in the 800 pg series of standard mixes (FIG. 4C).

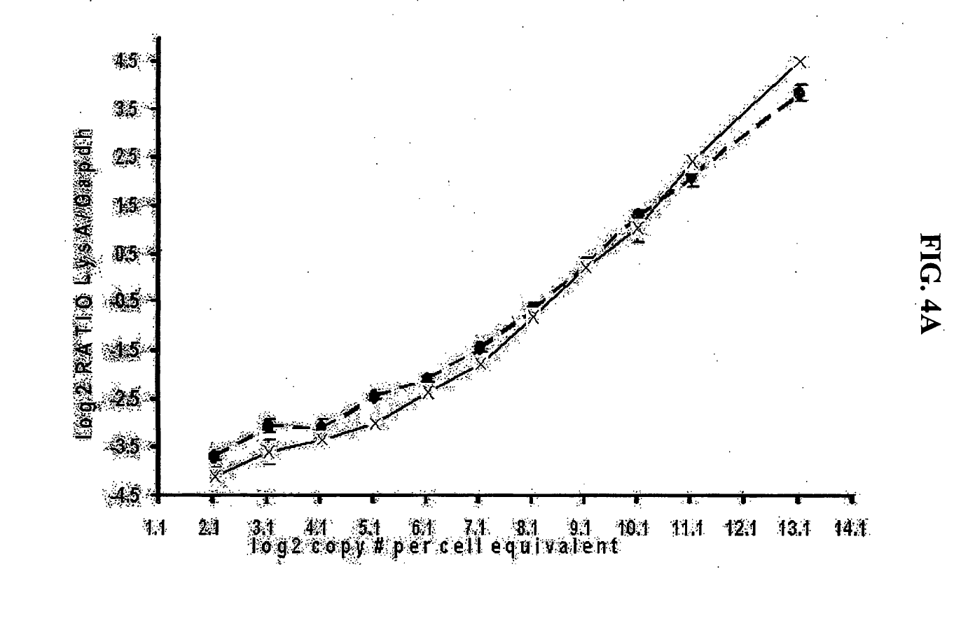

We compared REM technology to quantitative real time PCR by analyzing six of the standard mixes by both technologies. The real time PCR data, expressed as a negative log of the C_{T} value (Winer et al., 1999), and the REM data, expressed as the log₂ of the LysA/GAPDH ratio, are plotted on the y-axis in FIG. 5. The two data sets are compared across a set of known amounts of LysA, expressed as the log₂ of the LysA copy number per reaction or spot. This plot shows a striking parallel from an abundance of approximately 4 copies (log₂, 5.15) to 9100 copies (log₂, 15.15) of LysA per cell equivalent. Therefore, over a 2000 fold change in LysA abundance, REM technology is equal to quantitative real time PCR in accuracy and sensitivity.

A key feature of REM technology is its ability to represent a broad range of pathophysiological paradigms on a single product. However, valuable biological samples, such as biopsies or samples obtained by laser capture micro-dissection provide only small amounts of mRNA (Emmert-Buck et al., 1996). This requires a method for amplification of the mRNA population while maintaining the relative balance in abundance between mRNA species (Luo et al., 1999; Luzzi et al., 2003; Fink et al., 2002). One approach is the production of aRNA (Eberwine, 1996) and another is the production of SMART cDNAs (Chenchik et al., 1998; Zhu et al., 2001; Zhumabayeva et al., 2001). We have used SMART cDNAs because they meet the amplification criteria and are double stranded DNA that is very stable when printed on glass slides.

The SMART cDNA protocol synthesizes cDNAs from mRNAs using novel primers that allow second strand synthesis and subsequent PCR amplification of the double stranded cDNAs (Chenchil et al., 1998). This protocol uses a minimum number of PCR amplification cycles (approx. 15) and SMART cDNAs have been shown to preserve the relative abundance of different mRNAs in complex cDNA mixes (Wang et al., 2000; Kestler et al., 2000; Becker et al., 2001; Vernon et al., 2000). We printed SMART cDNAs synthesized from mRNA isolated from five tumor/normal pairs from five major tumor types (kidney, breast, uterus, lung and ovary). The SMART cDNAs were printed at 100, 200, 400, and 800 pgs per spot, and each SMART cDNA sample was printed in quadruplicate.

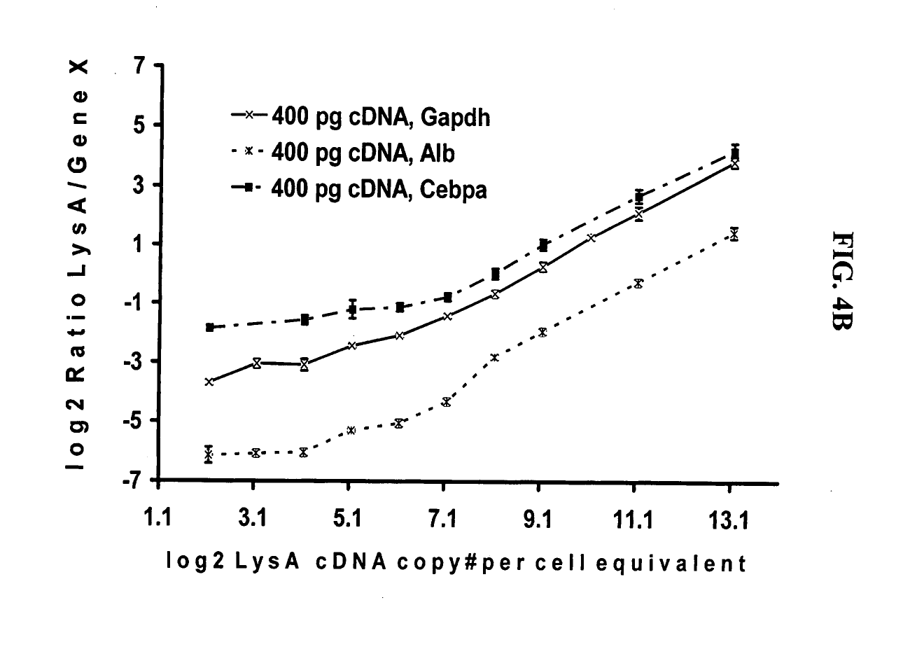

Hybridization of a REM containing SMART cDNAs, with a single stranded antisense Cy5 labeled probe to MYC, and a Cy3 labeled probe to β₂-microglobulin (b2M), as a housekeeping reference, produced significant fluorescence signals across the whole range of printing densities (FIG. 6A). The quadruplicate printing of each sample enabled us to calculate confidence intervals for each sample and draw a conclusion whether MYC was up or down regulated in the tumor from each tumor/normal pair. In the case of lung tumors, shown in FIG. 6B, we concluded that MYC was upregulated in all five tumors (100%). Up regulation of MYC in the lung tumor samples was confirmed using quantitative real time PCR. We calculated the δC_{T} value (Livak and Schmittgen, 2001) for each tumor sample versus its matching normal sample (numbers above each tumor/normal pair in FIG. 6B). A negative δC_{T} means that MYC was more abundant in the tumor sample compared to its matching normal sample (Livak and Schmittgen, 2001).

The ratio for MYC expression versus b2M was calculated for all 200 SMART cDNA spots representing twenty-five tumor/normal pairs, quadruplicate spotted. This survey showed a predominant up-regulation of MYC in lung and ovary tumors and down-regulation in kidney tumors (Table 3). In contrast, however, MYC was predominantly unchanged in our group of breast and uterus tumors (Table 3). The highest MYC up-regulation was found in two lung tumors that had 4.3 and 5.7 fold increases, and the most significant down-regulation of MYC was in kidney tumors.

TABLE 3

| Tissue | Rat N | s.d | Rat T | s.d | T/N | log₂ T/N | Category | Summary |
|---|---|---|---|---|---|---|---|---|
| breast 1 | 1.03 | 0.16 | 0.66 | 0.05 | 0.64 | −0.64 | down | 80% down |
| breast 2 | 0.53 | 0.06 | 0.54 | 0.04 | 1.02 | 0.03 | unchanged | 20% |
| breast 3 | 0.68 | 0.04 | 0.56 | 0.01 | 0.82 | −0.29 | down | unchanged |
| breast 4 | 1.01 | 0.04 | 0.35 | 0.01 | 0.35 | −1.51 | down | |
| breast 5 | 0.55 | 0.12 | 0.28 | 0.04 | 0.51 | −0.97 | down | |
| kidney 1 | 0.96 | 0.04 | 0.21 | 0 | 0.22 | −2.18 | down | 80% down |
| kidney 2 | 1.21 | 0.09 | 0.43 | 0.05 | 0.36 | −1.47 | down | 20% up |
| kidney 3 | 1.21 | 0.08 | 0.3 | 0.05 | 0.25 | −2 | down | |
| kidney 4 | 1.03 | 0.11 | 0.33 | 0.05 | 0.32 | −1.64 | down | |
| kidney 5 | 0.73 | 0.07 | 1.34 | 0.09 | 1.84 | 0.88 | up | |
| lung 1 | 0.4 | 0.05 | 0.66 | 0.06 | 1.65 | 0.72 | up | 100% up |
| lung 2 | 0.18 | 0.02 | 1.95 | 0.09 | 10.83 | 3.44 | up | |
| lung 3 | 0.46 | 0.05 | 0.92 | 0.07 | 2 | 1 | up | |
| lung 4 | 0.24 | 0.01 | 0.46 | 0.06 | 1.92 | 0.94 | up | |
| lung 5 | 0.18 | 0.02 | 1.29 | 0.24 | 7.17 | 2.84 | up | |
| ovary 1 | 0.41 | 0.04 | 0.33 | 0.02 | 0.8 | −0.32 | down | 40% up |
| ovary 2 | 0.4 | 0.06 | 0.43 | 0.04 | 1.08 | 0.11 | unchanged | 40% |
| ovary 3 | 0.33 | 0.03 | 1.36 | 0.02 | 4.12 | 2.04 | up | unchanged |
| ovary 4 | 0.67 | 0.03 | 1.63 | 0.11 | 2.43 | 1.28 | up | 20% down |
| ovary 5 | 0.53 | 0.06 | 0.55 | 0.05 | 1.04 | 0.06 | unchanged | |
| uterus 1 | 0.41 | 0.06 | 0.37 | 0.04 | 0.9 | −0.15 | unchanged | 40% |
| uterus 2 | 0.54 | 0.06 | 0.54 | 0.05 | 1 | 0 | unchanged | unchanged |
| uterus 3 | 0.81 | 0.03 | 0.31 | 0.03 | 0.38 | −1.4 | down | 40% down |
| uterus 4 | 0.54 | 0.11 | 0.38 | 0.02 | 0.7 | −0.51 | down | 20% up |
| uterus 5 | 0.96 | 0.02 | 1.15 | 0.04 | 1.2 | 0.26 | up | |

In this report we have validated REM Technology for measuring the expression of test genes in a diverse spectrum of biological samples in a high throughput manner. We have demonstrated that REM technology can detect organ specific gene expression of both abundant and rare mRNAs. Furthermore, we show that gene expression measurements can be normalized for different amounts of cDNA printed by using simultaneous hybridization of test and reference probes. In prototype REMs containing standardized mixes we demonstrated that gene specific signals can be measured down to two cDNA copies per liver cell equivalent. Furthermore, we demonstrated that REM technology is as sensitive and accurate as quantitative real time PCR for measuring abundance of specific templates over a 2000 fold range of dilutions.

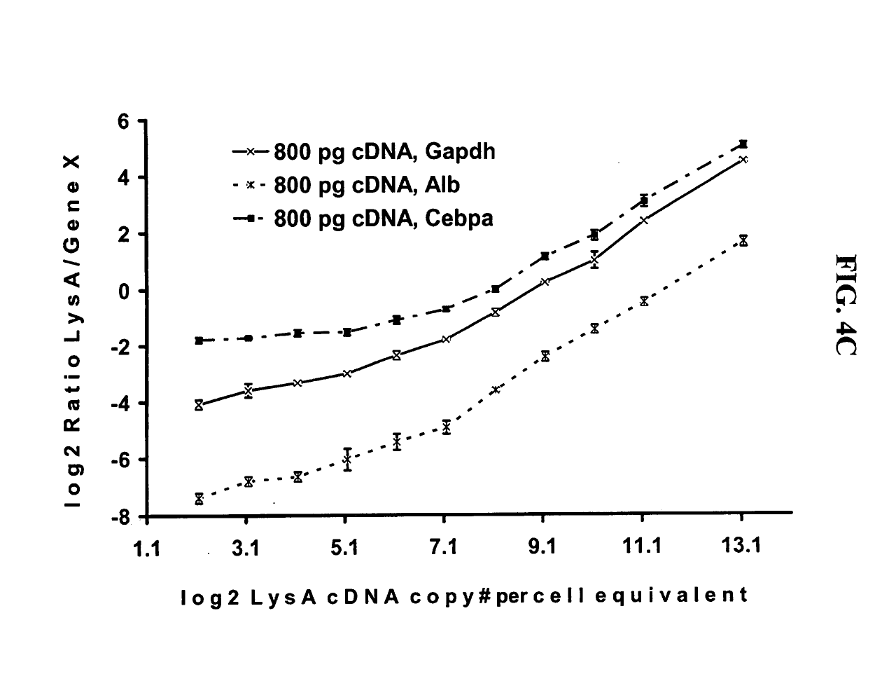

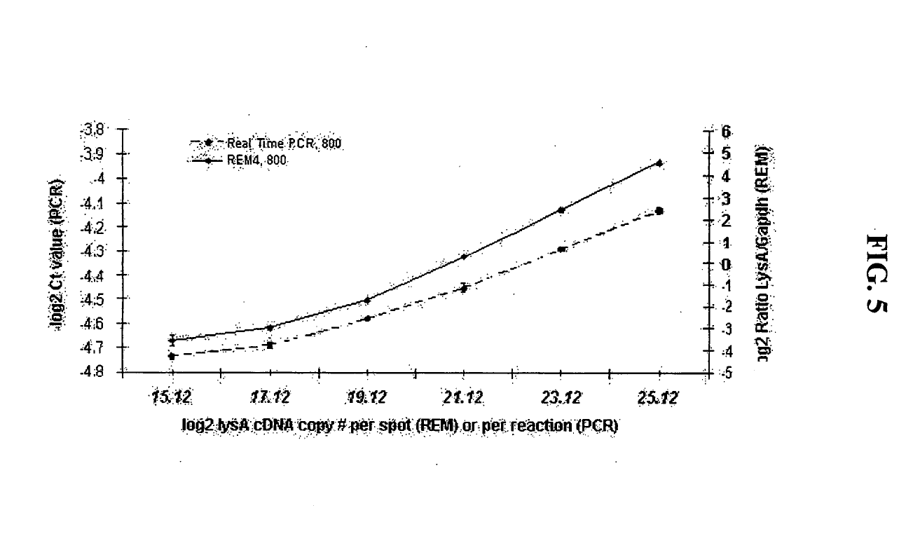

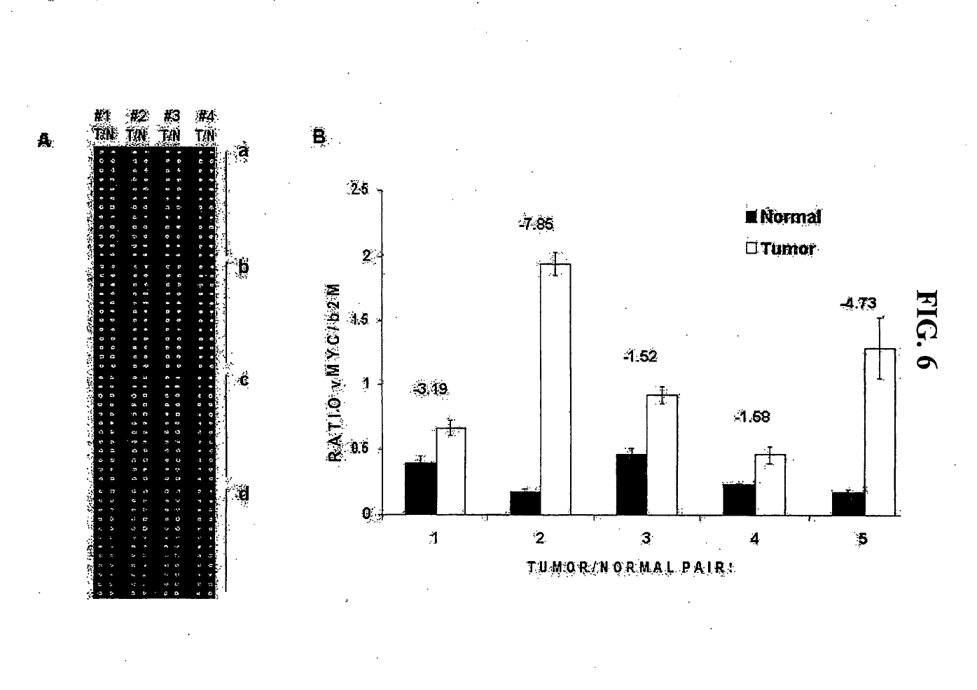

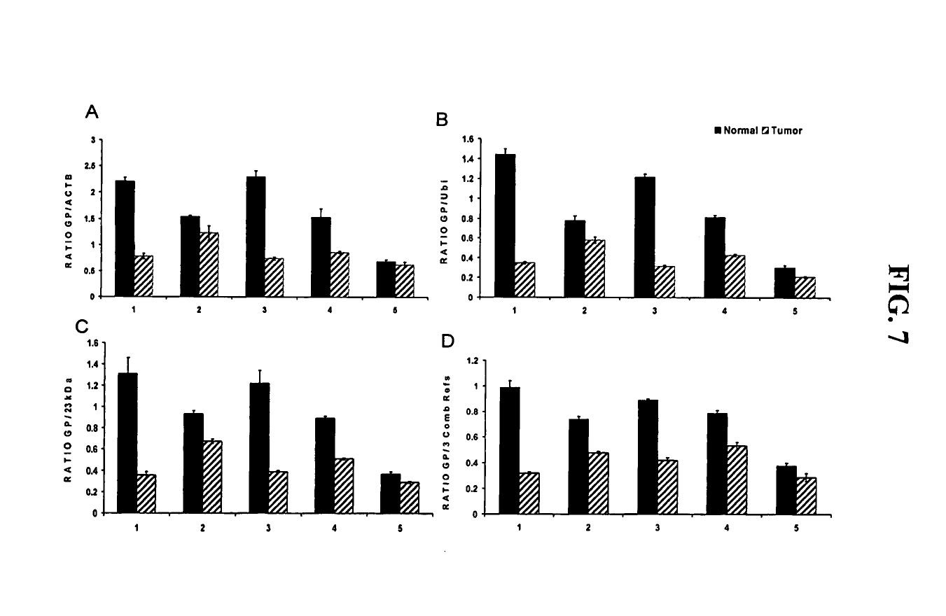

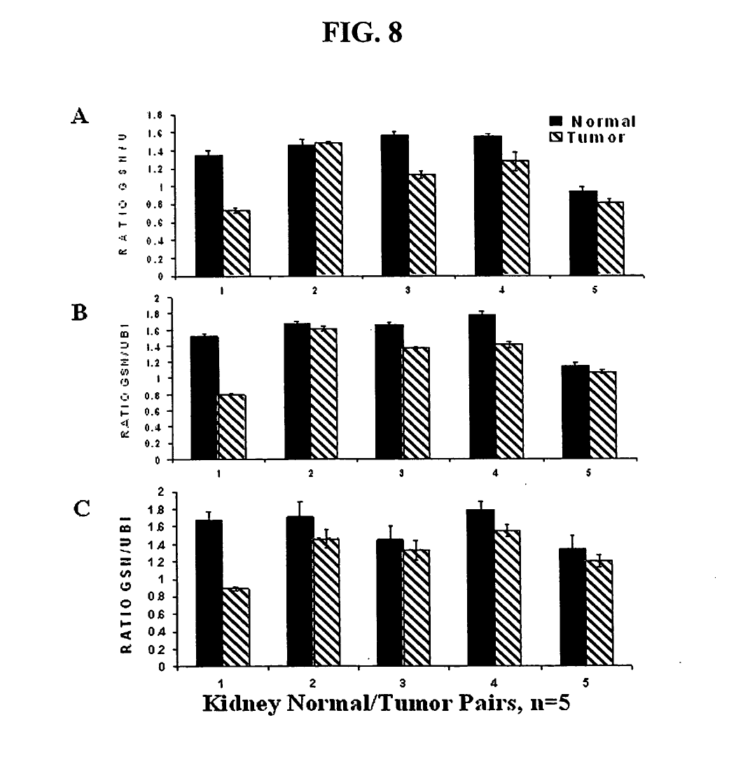

SMART™ cDNA synthesis provides a format for amplifying complex cDNAs while maintaining difference in abundance of different transcripts (Chenchik et al., 1998; Zhu et al., 2001; Zhumabayeva et al., 2001; Wang et al., 2000; Kestler et al., 2000; Becker et al., 2001). We printed SMART DNAs synthesized from matched tumor/normal pairs of tissues on a REM at multiple printing densities to determine the range of spotting densities for accurate quantitation. The ratios for expression of test genes were nearly identical in the entire range of spotting densities (100-800 pg/spot) that we tested (FIG. 8). Furthermore, when we used different reference genes versus the same test gene, the relative ratios for test gene expression were nearly identical (FIG. 7). These data showed that different reference genes, such as ubiquitin, β-actin, and 23 kDa basic protein can be used separately or in combination as internal reference controls.

We investigated the expression of the oncogene MYC in the SMART™ cDNA tumor/normal pairs. Data from quadruplicate spotted samples enabled us to calculate confidence intervals for the ratios for each tumor and normal sample. Therefore, we were able to draw conclusions as to differential oncogene expression in the paired samples at a level of sensitivity not previously possible for RNA dot blots (Kafotos et al., 1979). In a single REM containing twenty five tumor/normal pairs from five tumor types we were able to calculate the relative MYC expression and reach conclusions as to whether MYC was up, down or unchanged in the whole panel of tumor samples (Table 3). This survey serves as one example of how REM technology can be used in cancer research. Since thousands of samples can be printed on a single REM, REM Technology can provide a high throughput approach to testing candidate gene expression in diverse tissues and tumors.

The normalized data for GP in the tumor and normal pairs for the three reference genes separately and for the combination of reference genes is shown in FIG. 7. This experiment revealed a strikingly similar pattern of tumor/normal differences, using all three reference genes and the mixture of reference probes. As expected, the absolute ratios differed with each reference probe because of their different abundance. However, the qualitative conclusions as to differences between the tumor/normal samples were the same for each pair in all four independent hybridizations. As expected, the one example of data for the three different reference genes and the mixture is shown in FIG. 8 for GP expression in tumor/normal pairs. These data showed GP down-regulation in four out of five of the kidney tumor/normal pairs, which is in agreement with previously published data using similar samples on nylon arrays (Zhumabayeva et al., 2001). However, the REM data are much more quantitative.

We also printed SMART cDNAs at four densities, 100, 200, 400 and 800 pgs per spot. We then analyzed the gene expression ratios for pairs of probes over the four spotting densities. In all cases, we saw a very close correlation between the relative gene expression values in tumor/normal pairs over the different spotting densities. One example of the close correlation we observed is shown for a set of kidney tumor normal pairs hybridized with a gelsolin (GSN) probe and an ubiquitin reference probe (FIG. 8). In this case, we observed a consistent small down-regulation of Gelsolin in four out of five of the kidney tumor/normal pairs, as previously reported for nylon arrays (Zhumabayeva et al., 2001).

The only other array-based approach designed to test samples from multiple tissue types simultaneously is tissue microarrays (Kononen et al., 1998). These arrays contain thin sections of multiple tissues on a microscope slide, allowing an investigator to determine gene expression using antibodies to detect protein in cells. Also, in situ hybridization of tissue microarrays provides information on the expression of a gene in specific cell types. However, antibody staining and in situ hybridization are not quantitative technologies and are labor intensive. Furthermore, due to the nature of the experimental approach each section cut from the array is different from the previous section. Also, these arrays are limited to fewer than one hundred samples whereas REMs can easily accommodate thousands of samples that are spotted more than once for quantitative analysis.

Therefore, REM Technology fulfills an important need for a high throughput, sensitive, accurate, and quantitative method to measure gene expression simultaneously in multiple tissues or cell types, at a time in biological research when there is a strong emphasis on quantitative expression analysis. REMs provide a platform on which to build libraries of samples that can be used to characterize specific functions of genes in specific biological contexts. In addition to general survey REMs that contain samples from organs, tissues and cell types, specialty REMs that have experimental samples designed to ask specific questions about regulation of a gene in specific cellular contexts and developmental contexts, can be designed and produced. The future content and number of specialty REMs, (such as liver, kidney, heart, tumor profiles, developmental stages, and gene knockout REMs) and their application to biology is virtually unlimited. Therefore, we envision the library of REMs as continuing to grow and the impact of REMs on biological research to increase with time. The availability of REMs that have samples from classic experiments will provide researchers with access to relate their current research directly to historically validated paradigms. The use of reference REMs designed to ask questions in the area of toxicology and pharmaceutical research may also gain use in the drug approval process.

### Methods

Preparation of fluorescent probes. Gene specific sense and antisense primers approximately 500 base pairs apart were identified near the 3′ end of the cDNA sequence of selected genes. A T7 promoter sequence was attached to the antisense primer and the cDNA fragment was PCR amplified, purified using the Qiaquick PCR purification kit and the product was sequence verified. An antisense RNA was synthesized using T7 RNA polymerase according to the Epicenter AmpliScribe T7 Flash transcription kit protocol, (Epicentre Cat #ASF3257), except that the reaction was carried out at 42° C. for one hour. The antisense RNA was purified using a RNeasy Mini kit from Qiagen (Cat 74104). Five micrograms of antisense RNA, at 0.3 μg/μl in H₂0, was annealed at 70° C. for five minutes with 6 μM sense primer. After annealing, Cy3 or Cy5 labeled sense strand cDNA was synthesized using 10 units/μl Invitrogen Superscript III reverse transcriptase, in 50 mM Tris HCl pH 8.3, 75 mM KCl, 3 mM MgCl₂, 10 mM DTT, 1 unit/μl RNaseOUT (Invitrogen, Cat #10777-019), 500 nM dATP, dCTP, dGTP and 200 nM dTTP, plus either Cy3 or Cy5 labeled dUTP at 100 nM, at 50° C. for two hours (reaction volume normally 40 μl). After completion of the reaction, MgCl₂ was added to 17.5 mM and Tris HCl, pH 7.4 to 250 mM and the solution was incubated 30 minutes at 37° C. with 4 units of RNAse H, followed by treatment with 0.5 units/μl of RNase 1 and RNase 1 buffer (10 mM TrisHCl, pH 7.5, 5 mM EDTA and 200 mM sodium acetate (Promega #4261) for 10 minutes at 37° C. Probe solutions containing either Cy3 or Cy5 were combined and purified together using a Qiaquick PCR purification kit. Final purification was accomplished by elution from the Qiagen columns using 10 mM TrisHCl (pH 8.5) as elution buffer (Qiagen protocol), the combined probes were precipitated by adding ⅓ volume of 7.5 M ammonium acetate, followed by 2.5 volumes of absolute ethanol, and precipitation at −80° C. for 20 minutes. The precipitates were collected by centrifugation at 13K in a microcentrifuge for 15′, the pellets were washed with 75% ethanol, and air-dried. Immediately before REM hybridization the pellet containing the combined Cy3 and Cy5 labeled probes was dissolved in 20 μl of hybridization buffer containing 35% formamide, 0.5% SDS, 2.5×Denhardt's solution, 4×SSPE, 0.2 μg/μl yeast tRNA, 0.1 μg/μl poly (dA), and 2.5 μg/μl mouse/human Cot 1 DNA. The probe was boiled at 95° C. for 2 minutes, snap cooled, spun down in a microcentrifuge at 13 K for 5 minutes, and prehybridized at 50° C. for one hour.

Preparation of REMs for hybridization. Dust from slide was removed with air from a Fisherbrand super friendly AirTT, (Cat #23-022523). The array face of the REM was moisturized over boiling water for 5 seconds and the DNA was immediately crosslinked to the slide with 250 mJ of UV irradiation in a BioRad UV GS GENE LINKER. The slide was remoisturized over steam for 5 seconds, and placed (array side up) on a 100° C. hot plate for 3-5 seconds. Then slide was rinsed in 0.1% SDS for 10-20 seconds, followed by ddH₂O for 10-20 seconds, and then incubated in a 95° C. ddH2O for 3-5 minutes. The slide was dipped in absolute ethanol and excess ethanol was removed by centrifugation in a 50 ml tube at 1000 rpm for four minutes. The slide was placed, array side up, in a microarray slide hybridization chamber. Approximately 20 μl of prehybridization solution (prehybridization solution is 35% formamide, 4×SSPE, 0.5% SDS, 2.5×Denhardt's, and 0.2 μg/ml salmon sperm DNA) was added over the arrayed samples and cover slip was placed over samples avoiding bubbles. The slide was incubated in the hybridization chamber that was humidified by adding 10 μl of water in each corner, for 1-2 hours at 50° C. After incubation the cover slip was removed by dipping in water, the slide was dried by centrifugation as above, dust was removed as above, slide was returned to the chamber, covered by hybridization solution containing a mixture of Cy3 and Cy5 labeled probes and by cover slip, and incubated in humidified hybridization chamber 16-20 hours at 50° C. After hybridization, the cover slip was removed by immersing the REM in 100 ml 2×SSC/0.1% SDS, then washed with several hundred milliliters of 0.2×SSC/0.1% SDS with stirring for 10-15 minutes at RT, washed with 0.2×SSC and then with 0.1×SSC each 15 minutes. The slide was dried by centrifugation as above, stored at RT, in the dark, until scanning (preferably the same day).

Preparation of single stranded LysA antisense cDNA and dilution into antisense liver cDNA. A 1 kilobase segment of a bacterial clone for diaminopimelate decarboxylase (LysA, ATCC accession number 87482), was subcloned into pBluescript II KS+. The clone contained a 60-nucleotide artificial polyA tail at its 3′ end. A 1.1 Kb DNA fragment was amplified from the plasmid using antisense T7 and sense T3 primers homologous to plasmid sequences and the PCR product was sequence verified. Sense strand LysA aRNA was synthesized using an Ambion MEGAscript T3 RNA Polymerase kit (Cat #1338). Antisense cDNA was synthesized from the full-length aRNA using an oligodT primer and Superscript II Reverse Transcriptase followed by removal of the RNA template with RNase 1 and purification of single strand antisense cDNA over a Qiagen PCR purification column (Cat. #28104). Purified products were measured by OD260, checked for correct size.

A large batch of single stranded liver cDNA was synthesized from 2.5 mg of total RNA from a C57/B16 female mouse and used as the carrier for all the LysA dilutions. LysA 1.1 Kb antisense LysA cDNA was mixed with liver cDNAs at twelve levels each representing a 2-fold dilution of LysA per liver cell cDNA equivalent. Our mixtures were based on a 50 μg/ml solution of 1000 bp segment of single stranded DNA containing 9.1×10¹³ molecules of DNA/ml (Sambrook and Russell, 2001, A6.5, A6.11-13). Based on the above standard, we made serial dilutions in which LysA was varied from 9000 down to 4 copies per liver cell equivalent. All mixes were prepared in 3×SSC solution. Mixtures were also based on 0.2 pg mRNA/liver cell.

Preparation of LysA sense Cy dye labeled probe for REM hybridization. A set of nested primers were used to generate a 533 bp subfragment of LysA from the 1.1 Kb antisense cDNA produced above. The gene specific primers for this PCR fragment were: T7-CGAGCAAAGCATTCTCATCA (sense) and TAATACGACTCACTATAGGGCTCCTCCAAGATTCAGCAC (antisense). T7 RNA polymerase was used to generate an antisense LysA aRNA, the 533 bp fragment (this aRNA did not contain either oligo dT or T7 polymerase promoter sequences). The final, approx 513 bp, sense strand Cy dye labeled LysA probe was synthesized from 5 μg antisense aRNA using the sense strand primer, at 30 pmole, and reverse transcriptase in the standard probe synthesis conditions described above.

Quantitation of LysA by Real Time PCR. TaqMan probe and primers were designed with Primer Express Software (Applied Biosystems) and synthesized by Operon (Qiagen) as follows: GAAACGGGTCACTCCATCGA (forward primer); AGTCATGCGTATGCGCTTCTAC (reverse primer), and 6FAM-TTCTTCTTCGGATCACGCCCGG-TAMRA (probe). The TaqMan rodent GAPDH Control Reagents containing VIC labeled probe and primers (P/N 4308313, Applied Biosystems) were used to quantify a reference gene expression. Serial dilutions of LysA cDNA mixed with mouse liver cDNA were prepared in a way that a particular reaction well contained the same amount of corresponding dilution that was printed on the REM slide. TaqMan Universal Master Mix (P/N 4304437) was used to prepare reaction mixtures containing 900 mM of each primer and 250 nM of appropriate TaqMan probe. We performed a single gene reaction for LysA or GAPDH, in each well. For each data point we had 3 repetitions and used 96-well optical PCR reaction plates (P/N 4306737, AB). The plates were sealed, spun down; and reactions run in an ABI PRISM 7000 Sequence Detection System under default conditions: 50° C. for 2 minutes, 95° C. for 10 minutes, and 40 cycles of 95° C. for 15 seconds and 600 C for 1 minute.

Primers for specific gene probes synthesis. All primers were selected using Primer 3 public available program, which can be found at http://www.broad.mit.edu/cgibin/primer/primer3.cgi/primer3_www.cgi. All suggested primers sequences were double checked for gene specificity using available gene databases. The following genes and primers were selected: MYC gene probe (NM_{—}002467-Homo sapiens v-myc myelocytomatosis viral oncogene homolog (avian)-AGAGAAGCTGGCCTCCTACC (forward), T7 (GTAATACGACTCACTATAGGG)GCCTCTTGACATTCTCCTCG (reverse), product size 632 bp; GP gene probe (X58295-plasma glutathione peroxidase 3), CATCTGACCGCCTCTTCTGG (forward), T7 (GTAATACGACTCACTATAGGG)CATCTGACCGCCTCTTCTGG (reverse), product size 308 bp; ACTB gene probe (X00351-Homo sapiens cytoplasmic β-actin), CTACGTCGCCCTGGACTTCGAGC (forward), T7, (GTAATACGACTCACTATAGGG)GATGGAGCCGCCGATCCACACGG (reverse), product size 384 bp; B2M gene probe (NM_{—}004048 Homo sapiens β₂-microglobulin) GTGCTCGCGCTACTCTCTCT (forward), T7 (GTAATACGACTCACTATAGGG) ACCTCTAAGTTGCCAGCCCT (reverse), product size 578 bp; 23-kDa highly basic protein (X56932 Homo sapiens ribosomal protein L13A (RPL13A); TAAACAGGTACTGCTGGGCCGGAAGGTG (forward), T7 (GTAATACGACTCACTATAGGG)CACGTTCTTCTCGGCCTGTTTCCGTAGC (reverse), product size 483 bp; Alb1 gene probe (NM_{—}009654 Mouse albumin 1), GACAAGGAAAGCTGCCTGAC (forward), T7 (GTAATACGACTCACTATAGGG) AGTTGGGGTTGACACCTGAG (reverse), product size 750 bp; GAPDH gene probe (NM_{—}008084 mouse glyceraldehyde-3-phosphate dehydrogenase), AACTTTGGCATTGTGGAAGG (forward), T7 (GTAATACGACTCACTATAGGG) TGTGAGGGAGATGCTCAGTG (reverse), product size 599 bp.

All specific PCR products were sequence verified and used as templates for antisense RNA synthesis by in vitro transcription followed by labeling procedure as described above.

Quantitative real time PCR assay for human MYC. Template: Samples of individual tumor or normal SMART cDNAs were diluted to obtain template amount of 400 pg per reaction. These amounts matched the amount of SMART cDNA printed on the REM. For the five pairs of Lung tumor/normal SMART cDNAs we tested three replications of each sample at the 400 pg/spot level. TaqMan primers and probes: Assay on Demand gene expression reagents were from Applied Biosystems. Each assay consisted of forward and reverse primers and MGB (Minor Groove Binder) probe with 6FAM at the 5′ end and non-fluorescent quencher at the 3′ end mixed in 20× dilutions. TaqMan Universal PCR master mix (P/N 4304437 AB) was diluted two-fold with water and appropriate amount of assay mix, and aliquots of 20 μl were dispensed into wells on the reaction plate (P/N 4306737, AB). 5 μl containing designated amounts of SMART cDNA were added to the reaction mixes. Target gene and reference gene assays were run as single reactions on the same plate. The following assays were used: Hs00153408_ml for MYC oncogene (NM_{—}02467); 5′-GCAGCGACTCTGAGGAGGAACAAGA, reporter position is between exon 2-3;

Hs00187842_ml for β₂-microglobulin (NM_{—}004048), forward primer 5′-AGGCTATCCAGCGTACTCCAAAGAT, reporter position is between exon 1-2;
Hs99999903_ml for β-actin (Gene Bank mRNA X00351), forward primer 5′-TCGCCTTTGCCGATCCGCCGCCCGT, reporter position is exon 1.

Synthesis of cDNAs for printing. Total RNA was isolated using the Qiagen RNA purification procedure (Qiagen #75144) according to manufacturer's instructions. RNA quality was monitored using an Agilent 2100 bioanalyzer (LabChip, Caliper Technologies Corp.). Invitrogen Superscript III reverse transcriptase (Cat #180080-044) was used to synthesize cDNA from 100 μg of total RNA. After synthesis was completed, samples were heated at 94° C. for 2 minutes, and then treated with 0.5 units/μl of RNase I and RNase I Buffer (10 mM TrisHCl (pH 7.5), 5 mM EDTA and 200 mM sodium acetate (Promega #4261) for 10 minutes at 37° C. Single stranded cDNA was separated using the Qiaquick PCR purification protocol (Qiaquick Spin Handbook, p18), except that an additional 35% guanidine hydrochloride wash step was included after binding cDNA to the Qiaquick column. CDNA was eluted with 10 mM Tris-HCl pH 8.5, and precipitated with one third volume 7.5 M ammonium acetate and 2.5 volumes of absolute ethanol. CDNA was pelleted, washed with 75% ethanol, and dissolved in water. Concentrations were adjusted to 200 or 400 ng/μl in 3×SSC for printing.

Microarray Printing Procedure for REM microarrays. The REM microarrays were produced with the custom-built microarray printer at the Albert Einstein College of Medicine (AECOM) Microarray Facility. Details of the equipment can be viewed on our website: http://microarraylk.aecom.yu.edu/. The printer configuration and parameters used for printing is as follows. Printhead & Pins: Telechem SPH48 printhead with pins spaced 4.5 mm center-to-center, populated with 16 split-tip pins, part#SMP3, arranged in a 4×4 array, each producing a nominal 100 μm diameter spot. Dot spacing: Each of the 16 pins forms a domain which was programmed to generate a uniformly spaced 12×12 square dot pattern, with a center-to-center dot spacing of 365 μm. Printing Parameters: The printing program was configured to produce 4 replicates of each sample for every microscope slide. This subdivides each domain area into 4 sub-domains containing 3×12 unique dots. With each pickup, each pin produces 4 equally spaced spots per domain, one each per sub-domain, from the same sample. The on-slide dwell time was 100 ms while the HEPA filtered environment was maintained at 25° C. and 50% RH. Microscope Slides The substrate used was the Corning GAPS II amino silane coated slides.

### EXAMPLE 2

### REMs can Detect 20% Differences in Organ Specific Expression

The data in Example 1 indicates that REM technology can detect small differences in abundance of endogenous mRNAs. This was further established with experiments using the following mixes of liver and kidney total RNA shown in Table 4.

TABLE 4
Liver/Kidney total RNA mixes

| Mix # | % Liver | % Kidney |
|---|---|---|
| 1 | 100 | 0 |
| 2 | 80 | 20 |
| 3 | 60 | 40 |
| 4 | 40 | 60 |
| 5 | 20 | 80 |
| 6 | 0 | 100 |

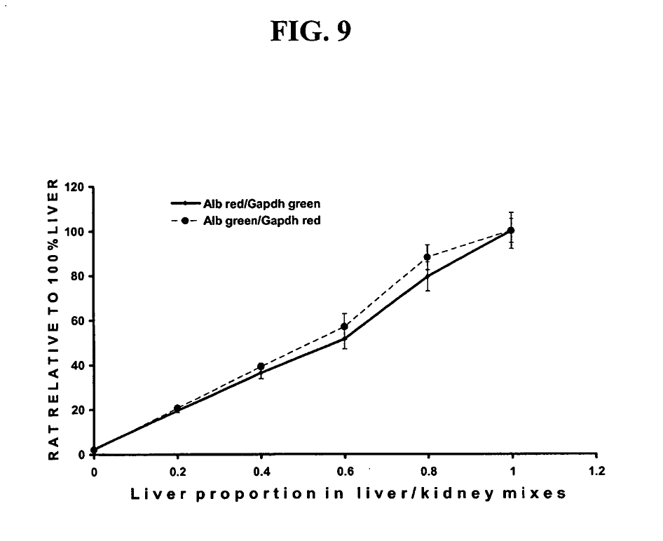

We prepared cDNA from each mixture using the anchored oligo dT method for cDNA synthesis and printed the cDNAs on a REM at either 200 or 400 pg/spot with 5× spotting of each cDNA. Two REMs were hybridized with Albumin (Cy5) and GAPDH (Cy3) or with reversed dyes, and the standard curves that were obtained for the ratio of albumin versus GAPDH hybridization is shown in FIG. 9. These data clearly demonstrate the REM Technology can detect 20% differences in mRNA abundance in an organ specific manner. Furthermore, the correlation coefficient for linearity was 0.99. To our knowledge, this is the first demonstration of a microarray technology that can accurately detect 20% differences in mRNA abundance. Routinely, the cutoff for significant differences in cDNA microarray technology are 50% differences or more.

These data also further validate the use of oligo dT priming of mRNAs in preserving the relative abundance of mRNAs in a complex mix. In this work, we utilized an anchor primed oligo dT method of cDNA synthesis in which only one nucleotide at the 3′ end of the oligo dT primer was either dA, dC, dG or dT. The anchored primers were: dC(dT)₂₄, dG(dT)₂₄, dA(dT)₂₄, and (dT)₂₄ mixed to 25 μM of each. The final concentration of the anchored primers in the reverse transcriptase reaction was 0.6 μM. Use of these primers anchored primers significantly reduced background and increased our yield and the size of cDNAs synthesized by reverse transcriptase.

### EXAMPLE 3

### Production of a Prototype Murine REM and its Use in the Detection of Differential Expression of Splice Variants of the Tumor Suppressor Gene. Mxi1

A murine REM was produced. The REM contained samples from 25 mouse organs and included organ samples from two genetic backgrounds, C57/B16 (inbred) and CD1 (outbred). Male and female adult mice were included for each organ.

Bioinformatics. A computer script that sorts, processes, and graphs the data from each of the groups of samples has been produced using a Linux operating system. Gridding the REM after hybridization and processing the data was by Gene Pix3.

Rationale for Splice Variant Research. With the unexpectedly low number of eukaryotic genes, the presence of mRNA splice variants has become a major focus of research (Modrek and Lee, 2002). The number of genes with functionally distinct isofomms produced from splice variants is increasing steadily (Resch et al., 2003). A key question is: Which of the functionally distinct isoforms are produced in different tissues and do these correlate with specific disease states or tumor susceptibilities.

Application. REM Technology offered an opportunity to determine the differential expression of splice variants of the Mxi1 tumor suppressor gene in all the major mouse organs using REM. Four splice variants of mouse Mxi1 (GenBank genomic accession ENSMUSG00000025025) (SRα, SRβ, β-Mxi1, and Mxi1-WR) have been mapped (Schreiber-Agus et al., 1994), and their different functional properties as antagonists of cMyc have been characterized. This family of proteins antagonizes cMyc activity by binding to Max, (the cMyc dimerization protein). SRα, a splice variant of Mxi1 binds more strongly to Max than a second splice variant SRβ, and is therefore more efficient as a repressor protein (Dugast-Darzacq et al., 2004). Therefore, differential expression of these two splice forms could have significant impact on cMyc oncogene action in different organs.

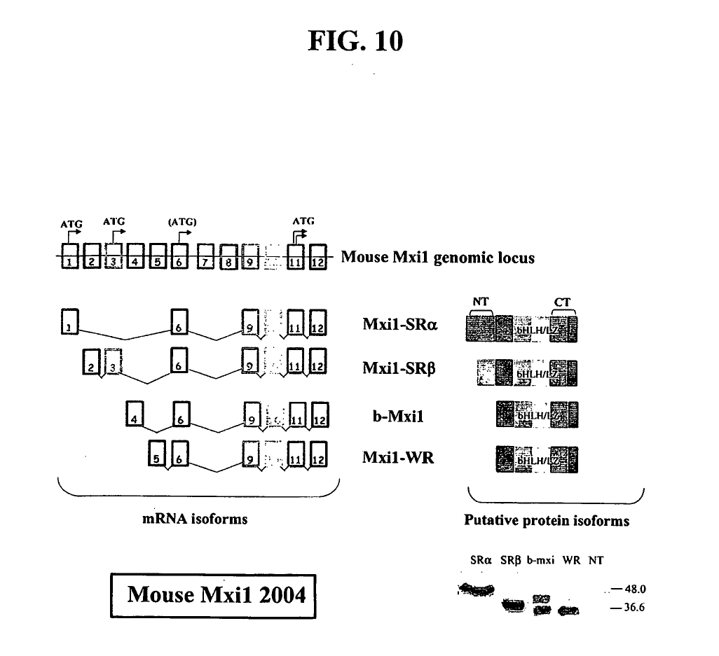

Experimental Design. We prepared three probes, one specific for SRα (GGCAAACGCGGGCGGCCGCGCAAGGAGGCGCGCTGCGAGGGCGCGGGGCTGGTCCC CGTCGCGCCCCCGGCCATGCCCCCGGCCGCGGCCGCGCCCCAGCCCCCGGCGCAGCC GGAGGAGCCGGCGGGGGCCAAGCCCCGGTGCCCCTTCTCGGACATTTTCAACACCAG CGAGAACTCGATGGAGAAGCACATCAACACTTfFCTGCAGAACGTGCAGATTCTGCT CGAGGCAGCCAGCTACCTGGAGCAGATCGAGAAGGAAAACAAAAAGTGTGAACATG GCTACGCCTCA), one specific for SRβ (GAAGTAAACAAACCGCGCGCGGGCTGCAGGCGGCGCGGCNGNCTCGGCGNGCNNG GCTAGGNNGGTGGANAGCGCNCCCACCCGGGNCCGACCTCGCCCGCCCGCCCGCCGC ACATGTCCGGAGTCGTCGTGGGACTGTAGCCGTCTGTGGCGCCTCCTGTCGGCCGGG GCGGAGCGCGAGCCATG), and one homologous to a common region (exon 6) present in all the Mxi1 transcripts (GATCTACACACAATGAGTTGGAAAAGAACCGACGAGCTCACCTGCGCCTGTGTTTA GAACGCTTGAAAGTTCTGATCCCGCTGGGCCCAGACTGCACCAGGCACACAACACTC GGTTTGCTCAACAAAGCCAAAGCACACATCAAGAAACTTGAAGAAGCGGAGAGGAA GAGCCAGCACCAGCTAGAGAACTTGGAACGAGAACAGAGGTTTTTAAAGCGGCGAC TGGAACAGCTGCAGGGGCCTCAGGAGATGGAGCGGATACGAATGGACAGCATTGGA TCAACCATCTCTTCAGATCGCTCGGATTCAGAGCGAGAGGAGATTGAAGTGGATGTG GAAAGCACAGAGTTCTCCCATGGAGAAGCAGACAGTGTCAGTACCACCAGCATCAGT GACCTTGACGACCACAGCAGCCTGCAGAGTGTCGGGAGTGACGAGGGTTATTCCAGT GCCAGTGTCAAACTC) (FIG. 10). The SRα and SRβ probes were labeled in red, and were hybridized to separate REM slides, along with a Green labeled “Common, Exon 6” probe that served as an internal normalization control for all Mxi1 transcripts.

Data Analysis. Analysis of splice variant abundance in organs of different mice revealed significant differences in individual mice. Data for organ specific expression of the two splice variants is shown in FIG. 11 for brain, heart, intestine, liver, and lung. The greatest differences were observed in SRα abundance (FIG. 11B).

Several fold elevated levels of SRα were observed in one heart, two intestine samples, one liver sample and one lung sample. In contrast, for the same set of cDNAs the SRβ appeared to show overall less variability, with less than one fold change (FIG. 11A). To test this, we did ANOVA analysis on data collected over nine organs from four mice (one male and one female each from CD1 and C57) for both SRα and SRβ. We took the logarithm of the ratio as the response (the two factors are organs and mice). The analysis showed that the variation between organs (MSB=1.27) in SRα is much higher than variation between organs (MSB=0.15) for SRβ. Therefore, we concluded that the SRα form was susceptible to wide variations in abundance and that these occurred in isolated mice within a population. In contrast, the abundance of the SRβ form was much more stable across the organs and mice.

Differential Spice Variant Data not due to artifact of cDNA synthesis. If the differences in splice variant data were due to different efficiencies of cDNA synthesis then these differences should be preserved across different splice variants for the same cDNA preparation. This is clearly not the case; for example, in several instances in FIG. 11, no difference is seen between samples for the SRβ variant in a particular organ, but one or two of the cDNAs show selective increases in the SRα variant. Therefore, the differential expression of the SRα splice variant represents a real and specific difference and not an artifact of cDNA synthesis.

Suggestion of genetically determined differences. In order to test whether there are genetically determined differences in splice variant abundance we compared an outbred strain, Male CD1, versus and inbred strain, Male C57B16, for differential expression of the SRα splice variant (FIG. 12 left). A two-way ANOVA analysis was performed on data from mouse organs. We used log-ratio as the response (to stabilize the variance) and organ and mice as the two factors. The analysis showed a statistically significant increase in the SRα variant across the set of CD1 organs compared to the c57B16 male (P-value=2.2e−16). This analysis confirmed a strong predisposition toward over-expression of the Srα splice variant specifically in the outbred Male CD1 mouse.

GAPDH data paralleled internal Mxi1 reference data. The above experiments used an internal common exon probe as a normalization control for the Mxi1 locus transcripts. In many cases, a common exon probe may not be available. Therefore, we used this opportunity to test whether a commonly used housekeeping gene, GAPDH, would yield similar data for the differential expression of the SRα probe. We hybridized another REM with the SRα probe and a GAPDH probe as the housekeeping gene. A large set of data were obtained that showed a close parallel between the two analyses. Two examples of the parallel nature of the data are shown in FIG. 12 Left & Right. This analysis revealed nearly identical patterns of SRα overexpression were observed with either the internal common exon probe or the GAPDH probe. These data provide independent confirmation of each other and support the validity of using GAPDH as a housekeeping gene when one is comparing gene expression among murine organs from healthy mice.

Mechanistic Significance. It is well known that certain individuals carry genetic predisposition to cancer (Kinzler and Vogelstein, 1996; Hahn and Weinberg, 2002). The genetic and/or epigenetic basis of individual susceptibility to cancer is poorly understood for most cancers. Data that can draw meaningful correlations between oncogene/tumor suppressor isoform expression in specific individual organs or genotypes with predisposition to specific tumors will significantly advance our understanding of the molecular and epidemiological basis for the cancer. REMs therefore have the capability to launch a whole new area of research that previously was not possible. The data presented are the first application of REMs for the above purpose

### EXAMPLE 4

### Development and Testing of MicroRNA REMs

Background. The field of RNA biology is undergoing a revolution with the expansion of research on the functions of naturally occurring microRNAs (miRNA). In particular, miRNAs have been linked to the control of cellular differentiation and cancer. As the number of miRNA genes continues to expand technologies for high throughput analysis of changes in miRNA expression are being developed. MiRNA gene microarrays have been produced by spotting miRNA oligonucleotides on glass microscope slides. These have been used to detect differential miRNA expression in small sets of samples.

Urgent need. In the miRNA field there is an urgent need for a high throughput technology to measure miRNA abundance in broad spectrums of biological samples. Here we describe our methods and data for validation of our prototype microREMs. A brief overview of method to produce microRNA REMs is listed below. A detailed protocol follows.

Method of production and testing of prototype MicroREM. We isolated a fraction of “small RNA” (≦200 nt, containing miRNAs) from liver and cultured hepatoma cells using a column separation method (Ambion mirVana miRNA isolation kit, Cat. No. 1560). Mixes of small RNA preps from liver and hepatoma cells were made in 20% increments (i.e. liver 100%, 80%, 60%, 40%, 20%, 0%, and vice versa for hepatoma). cDNA was synthesized from the small RNA mixes using random primed reverse transcription. cDNA preps from mixes (after RNase treatment) were printed to make a microREM. Sense strand 22 nucleotide mir122a, 22 probe was end-labeled with Cy5 and sense strand housekeeping probe to U6 RNA was labeled with Cy3. The microREM was simultaneously hybridized with both probes, washed and fluorescence read on an Axon scanner. A combined image shown in FIG. 13A.

Data plotted as the ratio of mir122a/U6 is shown in FIG. 13C and the average intensity of hybridization is in FIG. 13B.

Results. The data in FIG. 13 show the results of hybridizing a prototype REM that contained cDNA samples from mixes of liver and hepatoma cells. It was known that the mir122 microRNA was only present in the liver samples and thus the prediction was that there would be a straight line standard curve for the 20% increases in the amount of liver represented in the sets of spots. The microRNA REM was hybridized simultaneously with a mir122 probe and a U6 probe that served as the housekeeping gene. U6 should be the same in hepatoma and liver.

FIG. 13A shows the merged images of the hybridization. A dye swap experiment was done. Data on the left were for mir122 probe labeled in red and data spots on the right were for mir122 probe labeled in green. The reversal of the colors of the spots shows the hybridizations were specific and quantitative.

FIG. 13B shows the fluorescence intensities for the red (mir122) and green (U6) dyes for the left set of spots in FIG. 13A. The intensities were strong and the mir122 signals increased as expected whereas the U6 (green) signals were stable across the set of sample mixtures.

FIG. 13C shows the ratio data calculated from the Red/Green intensities of FIG. 13B. The straight line data with a 0.99 correlation coefficient shows that the standard curve could detect 20% differences in abundance. Therefore, the microREM technology we developed is capable of detecting at least 20% differences in miRNA levels.

Significance. This is a major advance in REM technology because it extends REM research into the new cutting edge area of microRNA research.

### EXAMPLE 5

### A Detailed Method for MicroRNA REM Production and Hybridization

Small RNA isolation was done by as described in Example 4. That protocol allows simultaneous isolation and separation of high and low molecular weight (≦200 nt) RNA species.

The synthesis of small RNA reverse complement CDNA was performed as follows. Ten μg of liver or hepatoma small RNA were precipitated in 1/10 volume 3M NaCOOH (pH 5.2) and 3 volumes of 100% ETOH. Pellets were washed in 80% ETOH and dissolved in 16 μl RNase free water.

2 μl of 3 μg/μl random primers (Invitrogen Cat#48190-011) was added to each tube containing 10 μg of particular small RNA mix and tubes were incubated at 65° C. and then chilled on ice.

The reaction mixture for reverse transcription was prepared as following:
8 μl 5× Superscript II buffer
4 μl DTT
4 μl 5 mM dNTPs
4 μl H2O
1 μl RNaseOut

After addition to annealed RNA/random primers mixture at room temperature, final mixture consisted of 50 mM Tris HCl pH 8.3, 75 mM KCl, 3 mM MgCl₂, 10 mM DTT, 1 unit/μl RNaseOUT (Invitrogen, Cat. No. 10777-019), 500 nM dNTPs.

The above mixture was incubated for few minutes at RT and then 400 units of Superscript H reverse transcriptase was added. After 10 min incubation at 25° C., tubes were transferred to 42° C. for 1 h. Superscript II reverse transcriptase (400 units) was again added and incubation was continued for an one additional hour.

After completion of the reaction, tubes were heated at 95° C. for 2 min and treated immediately with 0.5 units/μl of RNase1 and RNase1 buffer (10 mM TrisHCl, pH 7.5, 5 mM EDTA and 200 mM sodium acetate)(Promega Cat. No. 4261) for 10 minutes at 37° C. RNase1 was then inactivated by treatment for 1 min at 95° C.

The synthesized ssDNA was purified over Quick Spin Sephadex G-25 columns (Roche, Cat. No. 1273949) or with QIAquick Nucleotide Removal Kit (Qiagen, Cat. No. 28304). The flow through (eluate) was precipitated in 1/10 volume of 3M NaCOOH (pH 5.2) and 3 volumes of 100% EtOH at −80° C. The pellets were washed with 80% EtOH, air dried and dissolved in 5 μl water. The small cDNA samples were brought to 3×SSC solution, placed into a 384-well plate and printed on Corning ULTRAGAPS slides as described earlier.

Probe preparation. Mature sequences in sense orientation for miR-122a (liver specific) 5′-TGGAGTGTGACAATGGTGTTTGT-3′ or miR-92 (found in hepatoma) 5′-TATTGCACTTGTCCCGGCCTG-3′ were used as microRNA probes. U6 snRNA specific oligonucleotide in sense orientation 5′-CGATACAGAGAAGTTAGCATGGCCCCTCTGC-3′ was used as a reference probe. Indicated oligonucleotides were labeled at the 5′-end with Cy3 or Cy5 dyes (Integrated DNA Technology, inc.) and 10 pmole of each were used in hybridization reaction.

Slide treatment. Slides were moisturized over boiling water and UV cross linked in BioRad Gene Linker at 600 mJ. Then slides were moisturized again, heated on the hot plate for 3-5 sec, rinsed in 0.1% SDS and then in water, and dunked in 100% ethanol. Hybridization was carried out at the same conditions as was reported before, except that temperature was reduced to 37° C.

### EXAMPLE 6

### Production and Testing of a MicroRNA Gene Array Overview

Methods for preparing microRNA Gene Arrays have been published as stated and cited earlier. Our method uses the following novel techniques for oligo synthesis and hybridization that, when put together in one application, create a microRNA gene array that is preferable to currently available array platforms.

### Methods

Single stranded DNA oligonucleotides of 20-22 nucleotides were synthesized. These oligonucleotides were homologous to the mature sense miRNA (designated Sense miRNA) or the antisense copy (designated Antisense miRNA) of the mature sense miRNA. The Antisense miRNA is a negative control for specificity. In some cases, locked nucleic acids (Kurreck et al., 2002)((LNA's, Exiqon Corporation) were included at approximately one base in every three bases, in the 20-22 mer oligonucleotides.

The normal and LNA modified oligonucleotides (without amino modification on the 3′end) were printed onto Corning UltraGap 2 microscope slides at varying densities from 2 fmole/spot to 80 fmole/spot. Each spot was replicated 5 times. The slides were processed for hybridization as described in the above examples for standard cDNA microarrays.

The target was prepared for hybridization by first isolating a fraction of “small RNA” from a total RNA preparation (as described in above examples) from tissue or cell samples. cDNAs were prepared and fluorescently labeled by standard methods using reverse transcriptase and random six oligonucleotide primers using standard methods. The microRNA gene arrays were hybridized at high stringency. The arrays were then washed and scanned as described in above examples. A computer program was used to sort and graph the data according to variables of miRNA gene identity, sense or antisense signals and level of printing signals.

Experiment 1: Analysis of miRNA Levels in Male and Female Liver Using a Prototype microRNA Gene Array.

Fluorescent labeled probe was synthesized from (a) small RNA from male liver (red) and (b) small RNA from female liver (green). These two probes were simultaneously hybridized to an array containing standard microRNA oligonucleotides with no modifications. The intensities of the red and green signals were used to calculate the ratio of male/female of the hybridization signals. Data are shown in FIG. 14. As shown in FIG. 14, this method is capable of detecting the presence of specific miRNAs that vary in abundance in a complex mixture of liver small RNAs. Male/female differences were seen with several of the probes.

Experiment 2: Testing the Effect of Addition of Locked Nucleic Acids to the microRNA Oligonucleotides Printed on the Array.

LNAs were incorporated into the oligonucleotides for several microRNAs that are expressed in the liver. These LNA-modified oligonucleotides were printed side by side with unmodified oligonucleotides of the exact same sequence. The microRNA gene arrays were hybridized with red (Cy5) labeled probe from liver. The hybridization intensities to the mir122a gene on the array are shown in FIG. 15; hybridization intensities to the mir92 gene are shown in FIG. 16.

As shown in FIGS. 15 and 16, LNA modified oligonucleotides hybridize approximately 10 greater than standard or amino modified oligonucleotides. This allows LNA modified oligonucleotides to detect the presence of microRNAs under conditions when standard oligonucleotides can not.

In view of the above, it will be seen that the several advantages of the invention are achieved and other advantages attained.

As various changes could be made in the above methods and compositions without departing from the scope of the invention, it is intended that all matter contained in the above description and shown in the accompanying drawings shall be interpreted as illustrative and not in a limiting sense.

All references cited in this specification are hereby incorporated by reference. The discussion of the references herein is intended merely to summarize the assertions made by the authors and no admission is made that any reference constitutes prior art. Applicants reserve the right to challenge the accuracy and pertinence of the cited references.

1. A microarray comprising a nonporous support, the microarray further comprising a plurality of spots, each spot affixed at identifiable locations on the surface of the support, wherein each spot comprises a mixture of cDNA molecules, the cDNA mixture being complementary and substantially quantitatively proportional to a mixture of mRNA molecules present in a cell or group of cells.

2. The method of claim 1, wherein the support is glass.

3. The microarray of claim 2, wherein the glass is silanized.

4. The microarray of claim 1, wherein the microarray is treated with UV light then heat.

5. The microarray of claim 1, wherein the support is 25 mm×75 mm.

6-11. (canceled)

12. The microarray of claim 1, wherein the cell or group of cells comprises eukaryotic cells.

13. The microarray of claim 1, wherein the mRNA is polyA-mRNA.

14. The microarray of claim 12, wherein each cell represented by each spot is from one tissue or organ.

15-16. (canceled)

17. The microarray of claim 14, wherein the cell or group of cells comprises a mammalian cell.

18. The microarray of claim 14, wherein each spot represents the mRNA population from different tissues of the same species.

19. The microarray of claim 14, wherein each of at least two spots represent the mRNA from the same tissue of different individuals of the same species.

20. The microarray of claim 19, wherein the different individuals were exposed to different environmental conditions.

21. The microarray of claim 19, wherein the different individuals vary in disease state.

22. The microarray of claim 19, wherein the different individuals vary in developmental stage.

23-26. (canceled)

27. A method for determining a normalized expression of a first gene in a cell or group of cells, the method comprising
creating the microarray of claim 1, wherein the mixture of cDNA in at least one spot substantially quantitatively represents the entire mRNA population in the cell or group of cells,
obtaining a first probe comprising a nucleic acid or mimetic complementary to at least a portion of the cDNA of the first gene, wherein the first probe further comprises a first detectable label,
obtaining a second probe comprising a nucleic acid or mimetic complementary to at least a portion of the cDNA of a first housekeeping gene in the cells of interest, wherein the second probe further comprises a second detectable label,
applying the first probe and the second probe to the microarray under conditions and for a time sufficient to allow specific hybridization of the first probe to the cDNA of the first gene and the second probe to the cDNA of the housekeeping gene,
washing the microarray to remove probes that are not specifically hybridized to the microarray spots,
quantifying the first detectable label from the first probe specifically hybridized to the gene of interest,
quantifying the second detectable label from the second probe specifically hybridized to the housekeeping gene, and
determining a ratio of the quantity of the first detectable label in relation to the second detectable label, wherein that ratio is the normalized expression of the first gene in the cell or group of cells.

28-31. (canceled)

32. The method of claim 27, wherein, before the applying step, the microarray is further treated with UV light then heat.

33-35. (canceled)

36. The method of claim 27, further comprising
obtaining a third probe comprising a nucleic acid or mimetic complementary to at least a portion of the cDNA of a second gene, wherein the third probe further comprises a third detectable label;
applying the third probe to the microarray under conditions and for a time sufficient to allow specific hybridization of the third probe to the cDNA of the second gene,
washing the microarray to remove any third probe that is not specifically hybridized to the microarray spots,
quantifying the third detectable label from the third probe specifically hybridized to the gene of interest, and
determining a ratio of the quantity of the third detectable label in relation to the second detectable label, wherein that ratio is the normalized expression of the second gene in the group of cells.

37-42. (canceled)

43. A method of determining the difference in normalized expression of a first gene between a first cell or group of cells and a second cell or group of cells, the method comprising
creating the microarray of claim 1, the microarray comprising
a first spot comprising a first mixture of cDNA molecules, the first mixture of cDNA molecules proportional and complementary to a mixture of mRNA substantially quantitatively representing the mRNA population from the first cell or group of cells; and
a second spot comprising a second mixture of cDNA molecules, the second mixture of cDNA molecules proportional and complementary to a second mixture of mRNA substantially quantitatively representing the mRNA population from the second cell or group of cells;
obtaining a first probe comprising a nucleic acid or mimetic complementary to at least a portion of the cDNA of the first gene, wherein the first probe further comprises a first detectable label;
obtaining a second probe comprising a nucleic acid or mimetic complementary to at least a portion of the cDNA of a housekeeping gene in the cells of interest, wherein the second probe further comprises a second detectable label;
applying the first probe and the second probe to the microarray under conditions and for a time sufficient to allow specific hybridization of the first probe to the cDNA of the first gene and the second probe to the cDNA of the housekeeping gene;
washing the microarray to remove probes that are not specifically hybridized to the microarray spots;
quantifying, at the first spot and the second spot, the first detectable label from the first probe specifically hybridized to the gene of interest;
quantifying, at the first spot and the second spot, the second detectable label from the second probe specifically hybridized to the housekeeping gene;
determining a ratio of the quantity of the first detectable label in relation to the second detectable label at the first spot, wherein that ratio is the normalized expression of the first gene in the first cell or group of cells;
determining a ratio of the quantity of the first detectable label in relation to the second detectable label at the second spot, wherein that ratio is the normalized expression of the first gene in the second cell or group of cells; and
determining the difference in the normalized expression of the first gene in the first cell or group of cells to the expression of the first gene in the second cell or group of cells.

44-54. (canceled)

55. A microarray comprising a substrate, the microarray further comprising a plurality of spots, each spot affixed at identifiable locations on the surface of the substrate, wherein each spot comprises a mixture of short RNA molecules less than 80 bases long, or DNA molecules complementary to the short RNA molecules, the short RNA molecules from a cell or group of cells.

56-60. (canceled)

61. A microarray comprising a substrate, the microarray further comprising a plurality of spots, each spot affixed at identifiable locations on the surface of the substrate, wherein each spot comprises a known short RNA or DNA complementary to the short RNA.

62-72. (canceled)


SEQUENCE LISTING (28 sequences)

SEQ ID NO: 1 - DNA, 20 bp, artificial
  sense primer used to generate 533 bp subfragment LysA aRNA
cgagcaaagcattctcatca

SEQ ID NO: 2 - DNA, 39 bp, artificial
  antisense primer used to generate 533 bp subfragment of Lysa
taatacgactcactatagggctcctccaagattcagcac

SEQ ID NO: 3 - DNA, 20 bp, artificial
  forward primer for LysA quantitation
gaaacgggtcactccatcga

SEQ ID NO: 4 - DNA, 22 bp, artificial
  reverse primer for LysA quantitation
agtcatgcgtatgcgcttctac

SEQ ID NO: 5 - DNA, 22 bp, artificial
  probe for LysA quantitation
ttcttcttcggatcacgcccgg

SEQ ID NO: 6 - DNA, 20 bp, artificial
  forward primer for MYC
agagaagctggcctcctacc

SEQ ID NO: 7 - DNA, 41 bp, artificial
  reverse primer for MYC
gtaatacgactcactataggggcctcttgacattctcctcg

SEQ ID NO: 8 - DNA, 20 bp, artificial
  forward primer for GP
catctgaccgcctcttctgg

SEQ ID NO: 9 - DNA, 41 bp, artificial
  reverse primer for GP
gtaatacgactcactatagggcatctgaccgcctcttctgg

SEQ ID NO: 10 - DNA, 23 bp, artificial
  forward primer for ACTB
ctacgtcgccctggacttcgagc

SEQ ID NO: 11 - DNA, 44 bp, artificial
  reverse primer for ACTB
gtaatacgactcactataggggatggagccgccgatccacacgg

SEQ ID NO: 12 - DNA, 20 bp, artificial
  forward primer for B2M
gtgctcgcgctactctctct

SEQ ID NO: 13 - DNA, 41 bp, artificial
  reverse primer for B2M
gtaatacgactcactatagggacctctaagttgccagccct

SEQ ID NO: 14 - DNA, 28 bp, artificial
  forward primer for L13A
taaacaggtactgctgggccggaaggtg

SEQ ID NO: 15 - DNA, 49 bp, artificial
  reverse primer for L13A
gtaatacgactcactatagggcacgttcttctcggcctgtttccgtagc

SEQ ID NO: 16 - DNA, 20 bp, artificial
  forward primer for Alb1
gacaaggaaagctgcctgac

SEQ ID NO: 17 - DNA, 41 bp, artificial
  reverse primer for Alb1
gtaatacgactcactatagggagttggggttgacacctgag

SEQ ID NO: 18 - DNA, 20 bp, artificial
  forward primer for GAPDH
aactttggcattgtggaagg

SEQ ID NO: 19 - DNA, 41 bp, artificial
  reverse primer for GAPDH
gtaatacgactcactatagggtgtgagggagatgctcagtg

SEQ ID NO: 20 - DNA, 25 bp, artificial
  primer for MYC oncogene
gcagcgactctgaggaggaacaaga

SEQ ID NO: 21 - DNA, 25 bp, artificial
  primer for beta2-microglobulin
aggctatccagcgtactccaaagat

SEQ ID NO: 22 - DNA, 25 bp, artificial
  primer for beta-actin
tcgcctttgccgatccgccgcccgt

SEQ ID NO: 23 - DNA, 294 bp, artificial
  probe for SR alpha
ggcaaacgcgggcggccgcgcaaggaggcgcgctgcgagggcgcggggctggtccccgtcgcgcccccggccatgcccccggccgcggccgcgccccagcccccggcgcagccggaggagccggcgggggccaagccccggtgccccttctcggacattttcaacaccagcgagaactcgatggagaagcacatcaacacttttctgcagaacgtgcagattctgctcgaggcagccagctacctggagcagatcgagaaggaaaacaaaaagtgtgaacatggctacgcctca

SEQ ID NO: 24 - DNA, 186 bp, artificial
  probe for SR betal
gaagtaaacaaaccgcgcgcgggctgcaggcggcgcggcngnctcggcgngcnnggctaggnnggtgganagcgcncccacccgggnccgacctcgcccgcccgcccgccgcacatgtccggagtcgtcgtgggactgtagccgtctgtggcgcctcctgtcggccggggcggagcgcgagccatg

SEQ ID NO: 25 - DNA, 467 bp, artificial
  probe for common region in all Mxi1 transcripts
gatctacacacaatgagttggaaaagaaccgacgagctcacctgcgcctgtgtttagaacgcttgaaagttctgatcccgctgggcccagactgcaccaggcacacaacactcggtttgctcaacaaagccaaagcacacatcaagaaacttgaagaagcggagaggaagagccagcaccagctagagaacttggaacgagaacagaggtttttaaagcggcgactggaacagctgcaggggcctcaggagatggagcggatacgaatggacagcattggatcaaccatctcttcagatcgctcggattcagagcgagaggagattgaagtggatgtggaaagcacagagttctcccatggagaagcagacagtgtcagtaccaccagcatcagtgaccttgacgaccacagcagcctgcagagtgtcgggagtgacgagggttattccagtgccagtgtcaaactc

SEQ ID NO: 26 - DNA, 23 bp, artificial
  probe for miR-122a
tggagtgtgacaatggtgtttgt

SEQ ID NO: 27 - DNA, 21 bp, artificial
  probe for miR-92
tattgcacttgtcccggcctg

SEQ ID NO: 28 - DNA, 31 bp, artificial
  U6 snRNA specific oligonucleotide
cgatacagagaagttagcatggcccctctgc